(19) United States
(12) Patent Application Publication
(10) Pub. No.: US 2005/0242204 A1
(43) Pub. Date: Nov. 3, 2005

(54) Leak-resistant drinking systems

(76) Inventors: Richard A. Ness, Goodyear, AZ (US); Dorothy L. Ness, Goodyear, AZ (US)

Correspondence Address: STONEMAN LAW OFFICES, LTD, 3113 NORTH 3RD STREET, PHOENIX, AZ, 85012, US

(21) Appl. No.: 11/118,936

(22) Filed: Apr. 28, 2005

Related U.S. Application Data
(60) Provisional application No. 60/567,398, filed on Apr. 30, 2004.
(60) Provisional application No. 60/569,159, filed on May 5, 2004.

(51) Int. Cl. E03B 9/20; B05B 12/14

(52) U.S. Cl. 239/24

(57) ABSTRACT

A leak-resistant drinking system is disclosed. The leak-resistant drinking system comprises squeeze-openable check valves for use with straws and cup lids, and tighteners to tighten the rim of a cup against the cup lid with expanding hygroscopic material.

### CROSS-REFERENCE TO RELATED APPLICATIONS

The present application is related to and claims priority from prior provisional application Ser. No. 60/567,398, filed Apr. 30, 2004, entitled “LEAK-RESISTANT DRINKING SYSTEMS”, and is also related to and claims priority from prior provisional application Ser. No. 60/569,159, filed May 5, 2004, entitled “DOUBLE-CHECK VALVE SYSTEM”, the contents of both of which are incorporated herein by this reference and are not admitted to be prior art with respect to the present invention by the mention in this cross-reference section.

### BACKGROUND

This invention relates to providing leak-resistant drinking systems.

Typically, cold drinks purchased at fast-food restaurants are provided with drinking straws for the convenience of the purchaser. Typically, hot coffee and tea are sold in insulated or thick paper cups with a flat plastic sipping lid or a domed plastic sipping lid. Typical domed plastic sipping lids have a raised edge with a small oval or racetrack shaped opening for sipping the hot drink. Typical plastic sipping lids may also have a separate perforated opening for inserting a straw. Other plastic cup lids have only a perforated straw opening. Plastic lids may leak if they are not tightly connected to the cup.

Typically, the fit of the straw in the opening is not water-tight. Typically, straws themselves permit the free flow of liquid and offer limited protection against leaks if the cup is knocked over. Typically, knocking over the cup easily dislodges cup lids.

Therefore, a need exists for a leak-resistant drinking system for cups with lids.

### OBJECTS AND FEATURES OF THE INVENTION

A primary object and feature of the present invention is to overcome the above-stated problems and meet the above-stated needs. A primary object and feature of the present invention is to provide leak-resistant drinking systems.

It is a further object and feature of the present invention to provide such a system having a double-check valve that is openable by pressure. It is a further object and feature of the present invention to provide such a system having a double-check valve that is openable by pressure from the lips, gums, or teeth. It is a further object and feature of the present invention to provide such a system having a positioner to properly orient the double-check valve in relation to the user. It is a further object and feature of the present invention to provide such a system having a fluid conduit.

It is a further object and feature of the present invention to provide such a system having an enlarged cushioned end. It is a further object and feature of the present invention to provide such a system having a single check valve that is openable by pressure from the lips and teeth.

It is a further object and feature of the present invention to provide such a system having a straw that fits and seals against the opening of a sipper lid. It is a further object and feature of the present invention to provide such a system having a stopper to position a conduit or valve in relation to a lid. It is a further object and feature of the present invention to provide such a system having ridges to position a conduit or valve in relation to a lid. It is a further object and feature of the present invention to provide such a system having adhesive sealant to position a conduit or valve in relation to a lid. It is a further object and feature of the present invention to provide such a system having a notched conduit or valve to position the conduit or valve in relation to a lid.

It is a further object and feature of the present invention to provide such a system comprising a double-check valve attachable to a sipper cup opening. It is a further object and feature of the present invention to provide such a system comprising a double-check valve attachable to a sipper cup opening, wherein the system has a large and comfortable end.

It is a further object and feature of the present invention to provide such a system comprising a duckbill valve openable within a conduit by squeezing one end that is outside of the conduit. It is a further object and feature of the present invention to provide such a system comprising a duckbill valve positionable entirely within a conduit. It is a further object and feature of the present invention to provide such a system comprising ratchets and a gasket for sealing the duckbill valve against the conduit.

It is a further object and feature of the present invention to provide such a system comprising moisture expandable material that expands to seal a cup against a lid. It is a further object and feature of the present invention to provide such a system comprising moisture expandable material placed in the rolled rim of a cup. It is a further object and feature of the present invention to provide such a system comprising a moisture expandable material embedded on a wick and placed in the rolled rim of a cup.

It is a further object and feature of the present invention to provide such a system comprising a connector adapted to connect a duckbill valve to a conduit.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a leak-resistant drinking system, relating to control of the flow of fluid through at least one valve, comprising: at least one first check valve to valve the forward flow of fluid; at least one second check valve to valve the backward flow of fluid; and at least one squeeze opener to squeeze open such at least one first check valve and such at least one second check valve simultaneously.

Moreover, it provides such a leak-resistant drinking system, wherein such at least one squeeze opener is operable by exactly one squeeze. Additionally, it provides such a leak-resistant drinking system, wherein such at least one first check valve comprises at least one first valve hinge adapted to assist opening of such at least one first check valve. Also, it provides such a leak-resistant drinking system, wherein such at least one second check valve comprises at least one second valve hinge adapted to assist opening of such at least one second check valve. In addition, it provides such a leak-resistant drinking system, further comprising at least one first resilient closure adapted to resiliently close such at least one first check valve. And, it provides such a leak-resistant drinking system, further comprising at least one second resilient closure adapted to resiliently close such at least one second check valve.

In accordance with another preferred embodiment hereof, this invention provides a leak-resistant drinking system, relating to control of the flow of fluid through at least one conduit, comprising: at least one conduit to conduct at least one fluid; at least one double-check squeeze valve adapted to double-check squeeze valve control of the flow of the at least one fluid through such at least one conduit, wherein such at least one double-check squeeze valve comprises at least one first check valve to valve the forward flow of fluid; at least one second check valve to valve the backward flow of fluid; and at least one squeeze opener to squeeze open such at least one first check valve and such at least one second check valve simultaneously; and at least one resilient closure adapted to resiliently close such at least one double-check squeeze valve wherein such at least one double-check squeeze valve is housed within such at least one conduit and wherein such at least one double-check squeeze valve is openable by at least one squeeze transmittable to such at least one conduit adjacent such at least one double-check squeeze valve.

Further, it provides such a leak-resistant drinking system, wherein such at least one double-check squeeze valve comprises at least one single squeeze opener to open such at least one double-check squeeze valve with a single squeeze. Even further, it provides such a leak-resistant drinking system, wherein such at least one double-check squeeze valve comprises at least one valve hinge to assist opening of such at least one double-check squeeze valve. Moreover, it provides such a leak-resistant drinking system, wherein such at least one conduit comprises at least one positioner to position such at least one double-check squeeze valve in a correct orientation relative to at least one user. Additionally, it provides such a leak-resistant drinking system, wherein such at least one positioner comprises such at least one conduit, wherein such at least one conduit is permanently angled. Also, it provides such a leak-resistant drinking system, wherein such at least one conduit comprises at least one tapered distal end to taper at least one distal end of such at least one conduit.

In addition, it provides such a leak-resistant drinking system, wherein such at least one conduit comprises at least one truncated tapered distal end to taper at least one truncated distal end of such at least one conduit. And, it provides such a leak-resistant drinking system, wherein such at least one conduit comprises at least one valve holder to hold such at least one double-check squeeze valve within such at least one conduit. Further, it provides such a leak-resistant drinking system, further comprising at least one cushion to cushion such at least one conduit. Even further, it provides such a leak-resistant drinking system, wherein such at least one cushion further comprises at least one indicia. Moreover, it provides such a leak-resistant drinking system, wherein such at least one cushion further comprises at least one resilient coating to resiliently coat such at least one cushion. Additionally, it provides such a leak-resistant drinking system, wherein such at least one resilient coating further comprises at least one conduit holder to hold such at least one conduit within such at least one resilient coating.

Also, it provides such a leak-resistant drinking system, wherein such at least one cushion further comprises at least one substantially spherically shaped portion. In addition, it provides such a leak-resistant drinking system, wherein such at least one cushion further comprises at least one substantially oblate shaped portion. And, it provides such a leak-resistant drinking system, further comprising: at least one cup to cup fluid; at least one cup lid to lid such at least one cup; and at least one conduit aperture adapted to pass such at least one conduit through such at least one cup lid. Further, it provides such a leak-resistant drinking system, wherein such at least one conduit comprises at least one positioner to position such at least one double-check squeeze valve relative to such at least one conduit aperture.

Even further, it provides such a leak-resistant drinking system, wherein such at least one positioner comprises adhesive to adhere such at least one conduit to such at least one cup lid. Moreover, it provides such a leak-resistant drinking system, wherein such at least one positioner comprises at least one notch in such at least one conduit to hold such at least one conduit within such at least one conduit aperture. Additionally, it provides such a leak-resistant drinking system, wherein such at least one positioning comprises at least one ridge on such at least one conduit to hold such at least one conduit within such at least one conduit aperture. Also, it provides such a leak-resistant drinking system, wherein such at least one positioner comprises at least one conduit holder to hold such at least one conduit within such at least one conduit aperture. In addition, it provides such a leak-resistant drinking system, wherein such at least one conduit extends less than about one inch through such at least one conduit aperture into such at least one cup.

And, it provides such a leak-resistant drinking system, wherein such at least one conduit extends through such at least one conduit aperture into such at least one cup substantially the distance between such at least one conduit aperture and at least one portion of at least one bottom of such at least one cup closest to such at least one conduit aperture. Further, it provides such a leak-resistant drinking system, wherein such at least one conduit extends through such at least one conduit aperture into such at least one cup substantially the distance between such at least one conduit aperture and at least one portion of at least one bottom of such at least one cup farthest from such at least one conduit aperture. Even further, it provides such a leak-resistant drinking system, wherein such at least one conduit comprises at least one tapered distal end to taper at least one distal end of such at least one conduit.

Moreover, it provides such a leak-resistant drinking system, wherein such at least one conduit comprises at least one truncated tapered distal end to taper at least one truncated distal end of such at least one conduit. Additionally, it provides such a leak-resistant drinking system, wherein at least one outside circumference of such at least one conduit substantially comprises at least one inside circumference of such at least one conduit aperture. Also, it provides such a leak-resistant drinking system, wherein such at least one cup comprises at least one sump to collect fluid in at least one bottom of such at least one cup. In addition, it provides such a leak-resistant drinking system, further comprising at least one cushion to cushion such at least one conduit. And, it provides such a leak-resistant drinking system, wherein such at least one cushion extends from at least one proximal end of such at least one conduit, along the length of such at least one conduit, to adjacent such at least one cup lid. Further, it provides such a leak-resistant drinking system, wherein such at least one cushion assists sealing such at least one conduit aperture. Even further, it provides such a leak-resistant drinking system, wherein at least one portion of such at least one cushion adheres to such at least one cup lid adjacent to such at least one conduit aperture.

In accordance with another preferred embodiment hereof, this invention provides a leak-resistant drinking system, relating to control of the flow of fluid through at least one conduit, comprising: at least one duckbill valve to duckbill valve the flow of fluid through the at least one conduit, wherein such at least one duckbill valve is locatable within the at least one conduit; at least one duckbill opener to open such at least one duckbill valve; and at least one duckbill seal to sealably engage the at least one conduit wherein such at least one duckbill seal is between such at least one duckbill valve and such at least one duckbill opener, and wherein such at least one duckbill seal is locatable within the at least one conduit; wherein squeezing of such at least one duckbill opener is operable to open such at least one duckbill valve.

Moreover, it provides such a leak-resistant drinking system, wherein such at least one duckbill seal further comprises at least one stop to stop such at least one duckbill squeeze valve relative to the at least one conduit. Additionally, it provides such a leak-resistant drinking system, wherein such at least one duckbill opener comprises at least one squeeze-stop to stop such at least one duckbill opener from being squeezed closed. Also, it provides such a leak-resistant drinking system, further comprising at least one conduit to conduct at least one fluid. In addition, it provides such a leak-resistant drinking system, wherein such at least one duckbill valve comprises at least two annular cylindrical wedges.

And, it provides such a leak-resistant drinking system, wherein such at least one duckbill opener is locatable within the at least one conduit. Further, it provides such a leak-resistant drinking system, wherein such at least one duckbill opener is locatable outside of the at least one conduit. Even further, it provides such a leak-resistant drinking system, further comprising the at least one conduit, wherein such at least one conduit comprises at least one flared proximal end. Moreover, it provides such a leak-resistant drinking system, wherein such at least one duckbill seal comprises at least one ratchet adapted to ratchet such at least one duckbill valve into such at least one conduit. Additionally, it provides such a leak-resistant drinking system, wherein such at least one duckbill seal comprises at least one gasket adapted to seal the exterior of such at least one conduit.

Also, it provides such a leak-resistant drinking system, wherein such at least one duckbill seal comprises at least one support adapted to support such at least one gasket. In addition, it provides such a leak-resistant drinking system, wherein such at least one gasket is substantially flat. And, it provides such a leak-resistant drinking system, wherein such at least one gasket is shaped to conform to the perimeter of the at least one conduit. Further, it provides such a leak-resistant drinking system, wherein such at least one duckbill seal comprises: at least one ratchet adapted to ratchet such at least one duckbill valve into such at least one conduit; and at least one gasket adapted to seal the exterior of such at least one conduit when such at least one duckbill valve is ratcheted into such at least one conduit.

In accordance with another preferred embodiment hereof, this invention provides a leak-resistant drinking system, related to sealing at least one cup against at least one cup lid, comprising: at least one resilient cup to resiliently cup at least one fluid wherein such at least one resilient cup comprises at least one rolled cup rim to provide at least one rolled cup rim of such at least one resilient cup; and at least one moisture-activatable expander to expand such at least one rolled cup rim upon contact with moisture wherein such at least one moisture-activatable expander lies within such at least one rolled cup rim.

Even further, it provides such a leak-resistant drinking system, wherein such at least one moisture-activatable expander comprises at least one support to support such at least one moisture-activatable expander. Even further, it provides such a leak-resistant drinking system, wherein such at least one support comprises at least one wick. Even further, it provides such a leak-resistant drinking system, further comprising at least one water excluder to exclude water from such at least one moisture-activatable expander prior to use. Even further, it provides such a leak-resistant drinking system, wherein such at least one moisture-activated expander comprises at least one psillium fiber. Even further, it provides such a leak-resistant drinking system, wherein such at least one moisture-activated expander comprises at least one hydroscopic polymer. Even further, it provides such a leak-resistant drinking system, wherein such at least one moisture-activatable expander comprises at least one polymethacrylate salt.

In accordance with another preferred embodiment hereof, this invention provides a leak-resistant drinking system, relating to connecting at least one duckbill valve to at least one conduit, comprising: at least one connector adapted to connect such at least one duckbill valve to such at least one conduit; wherein such at least one connector comprises at least one conduit connector adapted to connect to such at least one conduit; wherein such at least one connector comprises at least one duckbill valve connector adapted to connect to such at least one duckbill valve; wherein such at least one connector comprises at least one fluid passage adapted to permit fluid passage between such at least one conduit and such at least one duckbill valve.

Even further, it provides such a leak-resistant drinking system, wherein such at least one conduit connector comprises at least one screw. Even further, it provides such a leak-resistant drinking system, wherein such at least one conduit connector comprises at least one notch. Even further, it provides such a leak-resistant drinking system, wherein such at least one duckbill valve connector comprises at least one detent.

In accordance with a preferred embodiment hereof, this invention provides a leak-resistant drinking system, relating to control of the flow of fluid through at least one valve, comprising: first check valve means for valving the forward flow of fluid; second check valve means for valving the backward flow of fluid; and squeeze opener means for squeezing open such first check valve means and such second check valve means simultaneously.

Moreover, it provides such a leak-resistant drinking system, wherein such squeeze opener means is operable by exactly one squeeze. Additionally, it provides such a leak-resistant drinking system, wherein such first check valve means comprises first valve hinge means for assisting opening of such first check valve means. Also, it provides such a leak-resistant drinking system, wherein such second check valve means comprises second valve hinge means for assisting opening of such second check valve means. In addition, it provides such a leak-resistant drinking system, further comprising first resilient closure means for resiliently closing such first check valve means. And, it provides such a leak-resistant drinking system, further comprising second resilient closure means for resiliently closing such second check valve means. In accordance with another preferred embodiment hereof, this invention provides a leak-resistant drinking system, relating to control of the flow of fluid through at least one conduit, comprising: conduit means for conducting fluid; double-check squeeze valve means for double-check squeeze valve control of the flow of the fluid through such conduit means wherein such double-check squeeze valve means comprises first check valve means for valving the forward flow of fluid; second check valve means for valving the backward flow of fluid; and squeeze opener means for squeezing open such first check valve means and such second check valve means simultaneously; and resilient closure means for resiliently closing such double-check squeeze valve means wherein such double-check squeeze valve means is housed within such conduit means, and wherein such double-check squeeze valve means is openable by at least one squeeze transmittable to such conduit means adjacent such double-check squeeze valve means.

Further, it provides such a leak-resistant drinking system, wherein such double-check squeeze valve means comprises single squeeze opener means for opening such double-check squeeze valve means with a single squeeze. Even further, it provides such a leak-resistant drinking system, wherein such double-check squeeze valve means comprises valve hinge means for assisting opening of such double-check squeeze valve means.

Moreover, it provides such a leak-resistant drinking system, wherein such conduit means comprises positioner means for positioning such double-check squeeze valve means in a correct orientation relative to at least one user. Additionally, it provides such a leak-resistant drinking system, wherein such positioner means comprises such conduit means, wherein such conduit means is permanently angled. Also, it provides such a leak-resistant drinking system, wherein such conduit means comprises tapered distal end means for tapering at least one distal end of such conduit means. In addition, it provides such a leak-resistant drinking system, wherein such conduit means comprises truncated tapered distal end means for tapering at least one truncated distal end of such conduit means. And, it provides such a leak-resistant drinking system, wherein such conduit means comprises valve holder means for holding such double-check squeeze valve means within such conduit means.

Further, it provides such a leak-resistant drinking system, further comprising cushion means for cushioning such conduit means. Even further, it provides such a leak-resistant drinking system, wherein such cushion means further comprises indicia. Moreover, it provides such a leak-resistant drinking system, wherein such cushion means further comprises resilient coating means for resiliently coating such cushion means. Additionally, it provides such a leak-resistant drinking system, wherein such at least one resilient coating means further comprises conduit holder means for holding such conduit means within such resilient coating means. Also, it provides such a leak-resistant drinking system, wherein such cushion means further comprises at least one substantially spherically shaped portion. In addition, it provides such a leak-resistant drinking system, wherein such cushion means further comprises at least one substantially oblate shaped portion.

And, it provides such a leak-resistant drinking system, further comprising: cup means for cupping liquid; cup lid means for lidding such cup means; and conduit aperture means for passing such conduit means through such cup lid means.

Further, it provides such a leak-resistant drinking system, wherein such conduit means comprises positioner means for positioning such double-check squeeze valve means relative to such conduit aperture means. Even further, it provides such a leak-resistant drinking system, wherein such positioner means comprises adhesive means for adhering such conduit means to such cup lid means. Moreover, it provides such a leak-resistant drinking system, wherein such positioner means comprises notch means in such conduit means for holding such conduit means within such conduit aperture means. Additionally, it provides such a leak-resistant drinking system, wherein such positioner means comprises ridge means on such conduit means for holding such conduit means within such conduit aperture means.

Also, it provides such a leak-resistant drinking system, wherein such positioner means comprises conduit holder means for holding such conduit means within such conduit aperture means. In addition, it provides such a leak-resistant drinking system, wherein such conduit means extends less than about one inch through such conduit aperture means into such cup means. And, it provides such a leak-resistant drinking system, wherein such conduit means extends through such conduit aperture means into such cup means substantially the distance between such conduit aperture means and at least one portion of at least one bottom of such cup means closest to such conduit aperture means. Further, it provides such a leak-resistant drinking system, wherein such conduit means extends through such conduit aperture means into such cup means substantially the distance between such conduit aperture means and at least one portion of at least one bottom of such cup means farthest from such conduit aperture means.

Even further, it provides such a leak-resistant drinking system, wherein such conduit means comprises tapered distal end means for tapering at least one distal end of such conduit means. Moreover, it provides such a leak-resistant drinking system, wherein such conduit means comprises truncated tapered distal end means for tapering at least one truncated distal end of such conduit means. Additionally, it provides such a leak-resistant drinking system, wherein at least one outside circumference of such conduit means substantially comprises at least one inside circumference of such conduit aperture means. Also, it provides such a leak-resistant drinking system, wherein such cup means comprises sump means for collecting fluid in at least one bottom of such cup means.

In addition, it provides such a leak-resistant drinking system, further comprising cushion means for cushioning such conduit means. And, it provides such a leak-resistant drinking system, wherein such cushion means further comprises indicia. Further, it provides such a leak-resistant drinking system, wherein such cushion means further comprises resilient coating means for resiliently coating such cushion means. Even further, it provides such a leak-resistant drinking system, wherein such at least one resilient coating means further comprises conduit holder means for holding such conduit means within such resilient coating means. Moreover, it provides such a leak-resistant drinking system, wherein such cushion means extends from at least one proximal end of such conduit means, along the length of such conduit means, to adjacent such cup lid means. Additionally, it provides such a leak-resistant drinking system, wherein such cushion means assists sealing such conduit aperture means. Also, it provides such a leak-resistant drinking system, wherein at least one portion of such cushion means adheres to such cup lid means adjacent to such conduit aperture means. In addition, it provides such a leak-resistant drinking system, wherein such cushion means further comprises at least one substantially spherical shaped portion. And, it provides such a leak-resistant drinking system, wherein such cushion means further comprises at least one substantially oblate shaped portion.

In accordance with another preferred embodiment hereof, this invention provides a leak-resistant drinking system, relating to control of the flow of fluid through at least one conduit, comprising: duckbill valve means for duckbill valving the flow of fluid through the at least one conduit, wherein such duckbill valve means is locatable within the at least one conduit; duckbill opener means for opening such duckbill valve means, wherein such duckbill opener means is located outside of the at least one conduit; and duckbill seal means for sealably engaging the at least one conduit wherein such duckbill seal means is between such duckbill valve means and such duckbill opener means, and wherein such duckbill seal means is locatable within the at least one conduit; wherein squeezing of such duckbill opener means is operable to open such duckbill valve means.

Further, it provides such a leak-resistant drinking system, wherein such duckbill seal means further comprises stop means for stopping such duckbill squeeze valve means relative to the at least one conduit. Even further, it provides such a leak-resistant drinking system, wherein such duckbill opener means comprises squeeze-stop means for stopping such duckbill opener means from being squeezed closed. Moreover, it provides such a leak-resistant drinking system, further comprising conduit means for conducting fluid.

In accordance with another preferred embodiment hereof, this invention provides a leak-resistant drinking system, relating to control of the flow of fluid through at least one conduit, comprising: duckbill valve means for duckbill valving the flow of fluid through the at least one conduit, wherein such duckbill valve means is locatable within the at least one conduit; duckbill opener means for opening such duckbill valve means, wherein such duckbill opener means is locatable within the at least one conduit; and duckbill seal means for sealably engaging the at least one conduit wherein such duckbill seal means is between such duckbill valve means and such duckbill opener means, and wherein such duckbill seal means is locatable within the at least one conduit; wherein squeezing of such duckbill opener means is operable to open such duckbill valve means within the at least one conduit.

Additionally, it provides such a leak-resistant drinking system, wherein such duckbill opener means comprises squeeze-stop means for stopping such duckbill opener means from being squeezed closed. Also, it provides such a leak-resistant drinking system, further comprising conduit means for conducting fluid. Even further, it provides resilient closure means for resiliently closing such duckbill valve means. Also, it provides wherein such conduit means comprises at least one flared proximal end. Further, it provides wherein such duckbill valve means comprises at least two annular cylindrical wedges.

In accordance with another preferred embodiment hereof, this invention provides a leak-resistant drinking system, related to sealing at least one cup against at least one cup lid, comprising: resilient cup means for resiliently cupping liquid wherein such resilient cup means comprises rolled cup rim means for providing at least one rolled cup rim of such resilient cup means; and moisture-activatable expander means for expanding such rolled cup rim means upon contact with moisture wherein such moisture-activatable expander means lies within such rolled cup rim means.

In addition, it provides such a leak-resistant drinking system, wherein such moisture-activatable expander means comprises support means for supporting such moisture-activatable expander means. And, it provides such a leak-resistant drinking system, wherein such support means comprises at least one wick. Further, it provides such a leak-resistant drinking system, further comprising water excluder means for excluding water from such moisture-activatable expander means prior to use. Even further, it provides such a leak-resistant drinking system, wherein such moisture-activatable expander means comprises at least one psillium fiber. Moreover, it provides such a leak-resistant drinking system, wherein such moisture-activatable expander means comprises at least one hydroscopic polymer.

In accordance with another preferred embodiment hereof, this invention provides a leak-resistant drinking system, relating to control of the flow of fluid through at least one valve, comprising: first check valve means for valving the flow of fluid; second check valve means for valving the flow of fluid; and squeeze opener means for squeezing open such first check valve means and such second check valve means simultaneously.

Additionally, it provides such a leak-resistant drinking system, wherein such squeeze opener means is operable by exactly one squeeze. Also, it provides such a leak-resistant drinking system, wherein such first check valve means comprises first valve hinge means for assisting opening of such first check valve means. In addition, it provides such a leak-resistant drinking system, wherein such second check valve means comprises second valve hinge means for assisting opening of such second check valve means. And, it provides such a leak-resistant drinking system, further comprising first resilient closure means for resiliently closing such first check valve means. Further, it provides such a leak-resistant drinking system, further comprising second resilient closure means for resiliently closing such second check valve means.

### BRIEF DESCRIPTION OF THE DRAWINGS

FIG. 1A shows a perspective view of a leak-resistant drinking system comprising a double-check squeeze valve according to a preferred embodiment of the present invention.

FIG. 1B shows an end-on view of the preferred embodiment according to FIG. 1A, in the closed position.

FIG. 1C shows an end-on view of the preferred embodiment according to FIG. 1A, in an open position.

FIG. 1D shows a side view of the preferred embodiment according to FIG. 1A, in the closed position.

FIG. 1E shows a sectional view of section 1E-1E of the preferred embodiment according to FIG. 1B.

FIG. 2 shows a perspective view of a leak-resistant drinking system comprising a double-check squeeze valve with a resilient outer layer according to a preferred embodiment of the present invention.

FIG. 3A shows a perspective view of a leak-resistant drinking system comprising a double-check squeeze valve with a resilient outer layer housed in a conduit, according to a preferred embodiment of the present invention.

FIG. 3B shows an end-on view of the preferred embodiment according to FIG. 3A, in the closed position.

FIG. 3C shows an end-on view of the preferred embodiment according to FIG. 3A, in an open position.

FIG. 3D shows a side view of the preferred embodiment according to FIG. 3A, in the closed position.

FIG. 3E shows a sectional view of section 3E-3E of the preferred embodiment according to FIG. 3B.

FIG. 4 shows a perspective view of a cup lid according to a preferred embodiment of the present invention.

FIG. 5A shows a perspective view of a leak-resistant drinking system according to a preferred embodiment of the present invention.

FIG. 5B shows a side view, partially in section, of the leak-resistant drinking system according to FIG. 5A.

FIG. 5C shows a front view, partially in section, of the leak-resistant drinking system according to FIG. 5A.

FIG. 5D shows a sectional view of section 5D-5D of the leak-resistant drinking system according to FIG. 5C.

FIG. 5E shows an enlargement of section 5E of the leak-resistant drinking system according to FIG. 5D.

FIG. 6A shows a perspective view of a leak-resistant drinking system according to a preferred embodiment of the present invention.

FIG. 6B shows a sectional view of section 6B-6B of the leak-resistant drinking system according to FIG. 6A.

FIG. 6C shows an enlargement of section 6C of the leak-resistant drinking system according to FIG. 6B.

FIG. 6D shows a front view of indicia on the leak-resistant drinking system according to FIG. 6A.

FIG. 7A shows a perspective view of a leak-resistant drinking system according to a preferred embodiment of the present invention.

FIG. 7B shows a sectional view of section 7B-7B of the leak-resistant drinking system according to FIG. 7A.

FIG. 7C shows an enlargement of section 7C of the leak-resistant drinking system according to FIG. 7B.

FIG. 8A shows a front view of a variation of the preferred embodiment of the present invention according to FIG. 7A, in the closed position.

FIG. 8B shows a front view of the leak-resistant drinking system according to FIG. 8A, in an open position.

FIG. 9A shows a perspective view of a leak-resistant drinking system according to a preferred embodiment of the present invention.

FIG. 9B shows a sectional view of section 9B-9B of the leak-resistant drinking system according to FIG. 9A.

FIG. 10 shows a sectional view of a leak-resistant drinking system according to a preferred embodiment of the present invention.

FIG. 11 shows a sectional view of a leak-resistant drinking system according to a preferred embodiment of the present invention.

FIG. 12A shows a perspective view of a leak-resistant drinking system according to a preferred embodiment of the present invention.

FIG. 12B shows a top plan view of the preferred embodiment according to FIG. 12A.

FIG. 12C shows a plan view of the preferred embodiment according to FIG. 12A.

FIG. 12D shows a perspective view of the preferred embodiment according to FIG. 12A, in use.

FIG. 12E shows a front view of the preferred embodiment according to FIG. 12A, in the closed position.

FIG. 12F shows a front view of the preferred embodiment according to FIG. 12A, in an open position.

FIG. 12G shows a side view of the preferred embodiment according to FIG. 12A, inserted into a conduit in the closed position.

FIG. 12H shows a sectional view of section 12H-12H of FIG. 12E.

FIG. 12I shows a side view of the preferred embodiment according to FIG. 12A, inserted into a conduit in the open position.

FIG. 12J shows a sectional view of section 12J-12J of FIG. 12F.

FIG. 13A shows a sectional view of a leak-resistant drinking system according to a preferred embodiment of the present invention, in the closed position.

FIG. 13B shows a sectional view of the preferred embodiment according to FIG. 13A, in an open position.

FIG. 13C shows a front view of the preferred embodiment according to FIG. 13A, in the closed position.

FIG. 13D shows a front view of the preferred embodiment according to FIG. 13A, in an open position.

FIG. 14A shows a side view of a leak-resistant drinking system according to a preferred embodiment of the present invention, in the closed position.

FIG. 14B shows a side view of the preferred embodiment according to FIG. 14A, in an open position.

FIG. 14C shows a sectional view of section 14C-14C of FIG. 14A.

FIG. 14D shows a sectional view of section 14D-14D of FIG. 14B.

FIG. 15A shows a sectional view of a leak-resistant drinking system according to a preferred embodiment of the present invention, in the closed position.

FIG. 15B shows a sectional view of the preferred embodiment according to FIG. 15A, in an open position.

FIG. 16A shows a side view of a leak-resistant drinking system according to a preferred embodiment of the present invention.

FIG. 16B shows a top plan view of the preferred embodiment according to FIG. 16A.

FIG. 16C shows a perspective view of the preferred embodiment according to FIG. 16A.

FIG. 16D shows a perspective view of the preferred embodiment according to FIG. 16A, inserted into a flared conduit.

FIG. 16E shows a sectional view of section 16E-16E of FIG. 16D, in the closed position.

FIG. 16F shows a sectional view of section 16E-16E of FIG. 16D, in an open position.

FIG. 17A shows a front view, partly in section, of a leak-resistant drinking system according to a preferred embodiment of the present invention, in a non-activated state.

FIG. 17B shows a front view, partly in section, of the preferred embodiment according to FIG. 17A, in an activated state.

FIG. 18A shows a front view, partly in section, of a leak-resistant drinking system according to a preferred embodiment of the present invention, in a non-activated state.

FIG. 18B shows a front view, partly in section, of the preferred embodiment according to FIG. 18A, in an activated state.

FIG. 19A shows a side view of a variation of the leak-resistant drinking system according FIG. 12A.

FIG. 19B shows a sectional view of section 19B-19B of FIG. 19A.

FIG. 19C shows a side view of a variation of the leak-resistant drinking system according to FIG. 19A.

FIG. 19D shows a sectional view of section 19D-19D of FIG. 19C.

FIG. 20A shows a side view of a leak-resistant drinking system according to a preferred embodiment of the present invention.

FIG. 20B shows a side view of the leak-resistant drinking system according FIG. 20A, installed in a conduit, and holding the variation of the leak-resistant drinking system according FIG. 12A.

FIG. 20C shows a sectional view of section 20C-20C of FIG. 20B.

### DETAILED DESCRIPTION OF THE BEST MODES AND PREFERRED EMBODIMENTS OF THE INVENTION

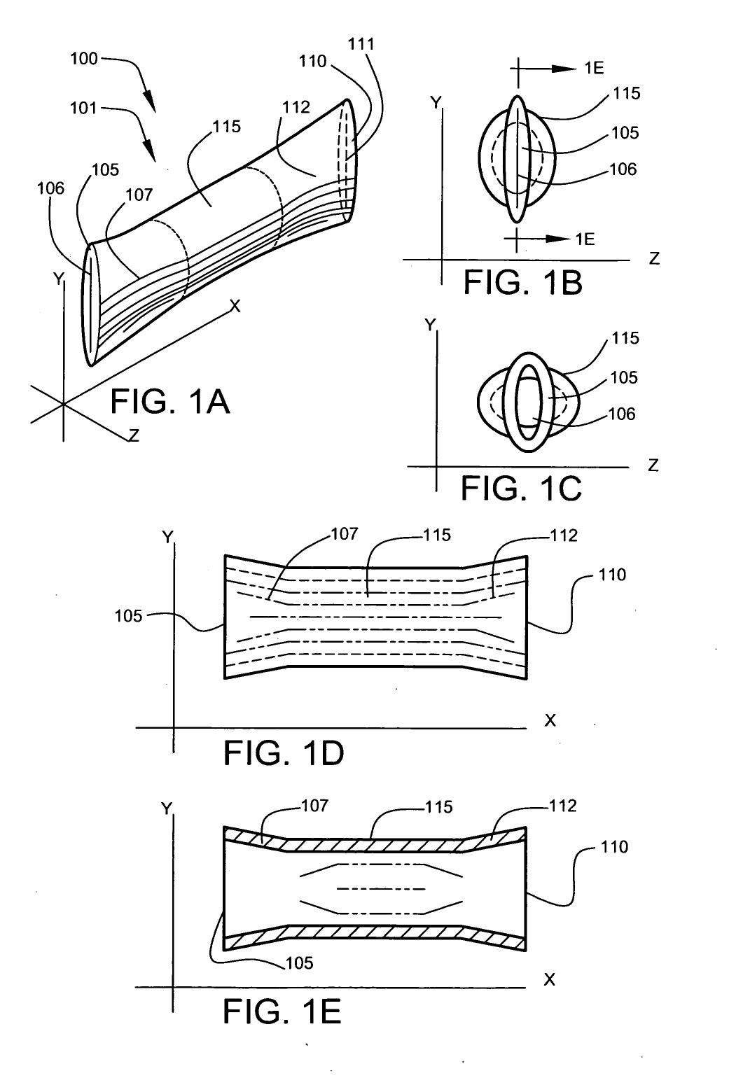

FIG. 1A shows a perspective view of leak-resistant drinking system 100 comprising double-check squeeze valve 101 according to a preferred embodiment of the present invention. Preferably, double-check squeeze valve 101 comprises a hollow, resilient tube comprising proximal end 105, proximal opening 106, distal end 110, distal opening 111, and squeeze portion 115, as shown. Preferably, proximal end 105 and proximal opening 106 comprise first check valve 107, as shown. Preferably, distal end 110 and distal opening 111 comprise second check valve 112, as shown.

For the purposes of this specification, the proximal end of an object is the end that is closest to the user, in use (i.e. the end of a valve that is placed in the user's mouth). For the purposes of this specification, the distal end of an object is the end that is farthest from the user, in use (i.e. the end of a valve that is placed in a cup of fluid).

For the purposes of this specification, wherever seals, adhesives, conduits, cushions, coatings, resilient layers, molded materials, etc., are called for in this specification and no other preference is stated, it is preferred to use in each case the least expensive material (which would suit the purposes of this application) commonly known to those of skill in the art.

Preferably, double-check squeeze valve 101 comprises strong, resilient material having shape memory, such as, for example, polyethylene, as shown. Upon reading the teachings of this specification, those of ordinary skill in the art will now understand that, under appropriate circumstances, such as user preference, advances in technology, intended use, etc., other materials, such as polyvinyl chloride, polypropylene, other plastics, silicone rubber, rubber, metal, etc., may suffice.

FIG. 1B shows an end-on view of the preferred embodiment according to FIG. 1A, in the closed position. Preferably, proximal end 105 and distal end 110 are compressed, and proximal opening 106 and distal opening 111 are closed (thus first check valve 107 is closed and second check valve 112 is closed), and squeeze portion 115 is slightly open, in the resting state, as shown. Preferably, proximal opening 106 and distal opening 111 each sealably close in the resting state, as shown, so that liquid cannot pass through either proximal opening 106 or distal opening 111. The slightly open resting state of squeeze portion 115 assists opening double-check squeeze valve 101 when squeeze portion 115 is squeezed. Upon reading the teachings of this specification, those of ordinary skill in the art will now understand that, under appropriate circumstances, such as user preference, advances in technology, intended use, etc., other arrangements, such as the squeeze section being flat in the resting state, first check valve and/or second check valve comprising soft, sealing materials such as, for example, rubber, silicone rubber, etc., may suffice.

FIG. 1C shows an end-on view of the preferred embodiment according to FIG. 1A, in an open position. Preferably, squeezing double-check squeeze valve 101 on squeeze portion 115 in the squeeze axis (the “Y” axis, as shown) results in squeeze portion 115 becoming shorter in the “Y” axis and wider in the “Z” axis, simultaneously deforming first check valve 107 and second check valve 112, and causing first check valve 107 and second check valve 112 to simultaneously open from the closed position, as shown. Preferably, the opened width of proximal opening 106 and distal opening 111 is dependent on the amount of squeeze pressure applied to squeeze portion 115. Preferably, when double-check squeeze valve 101 is in an open position, fluid may flow through double-check squeeze valve 101. Upon reading the teachings of this specification, those of ordinary skill in the art will now understand that, under appropriate circumstances, such as user preference, advances in technology, intended use, etc., other arrangements, such as proximal opening and distal opening opening fully with little dependence on the pressure applied, etc., may suffice.

Preferably, double-check squeeze valve 101 is openable by a single squeeze in the “Y” axis on squeeze portion 115, as shown, preferably with two fingers, or with the top and bottom teeth, gums, or lips of a user (at least embodying herein wherein such squeeze opener means is operable by exactly one squeeze, and also at least embodying herein wherein such double-check squeeze valve means is operable by exactly one squeeze; and at least embodying herein wherein such at least one squeeze opener is operable by exactly one squeeze, and also at least embodying herein wherein such at least one double-check squeeze valve is operable by exactly one squeeze). Accordingly, double-check squeeze valve 101 is preferably short enough that one squeeze anywhere on squeeze section 115 provides enough deformation to double-check squeeze valve 101 that both first check valve 107 and second check valve 112 open at the same time, as shown. More preferably, double-check squeeze valve 101 is between about one half inch and about three inches long in the “X” axis. Preferably, double-check squeeze valve 101 is small enough in the “Y” and “Z” axes to fit into conduit 330, such as, for example, drinking straw 530 (see FIG. 5A). More preferably, double-check squeeze valve 101 is between about one eighth inch and about one inch tall, at the tallest point, in the “Y” axis. More preferably, double-check squeeze valve 101 is between about one eighth inch and about one inch wide, at the widest point, in the “Z” axis. Upon reading the teachings of this specification, those of ordinary skill in the art will now understand that, under appropriate circumstances, such as user preference, advances in technology, intended use, etc., other arrangements, such as other sizes, the double-check squeeze valve being wider than it is tall, double-check squeeze valve having other shapes, double-check squeeze valve being a continuous portion of the wall of the conduit, etc., may suffice.

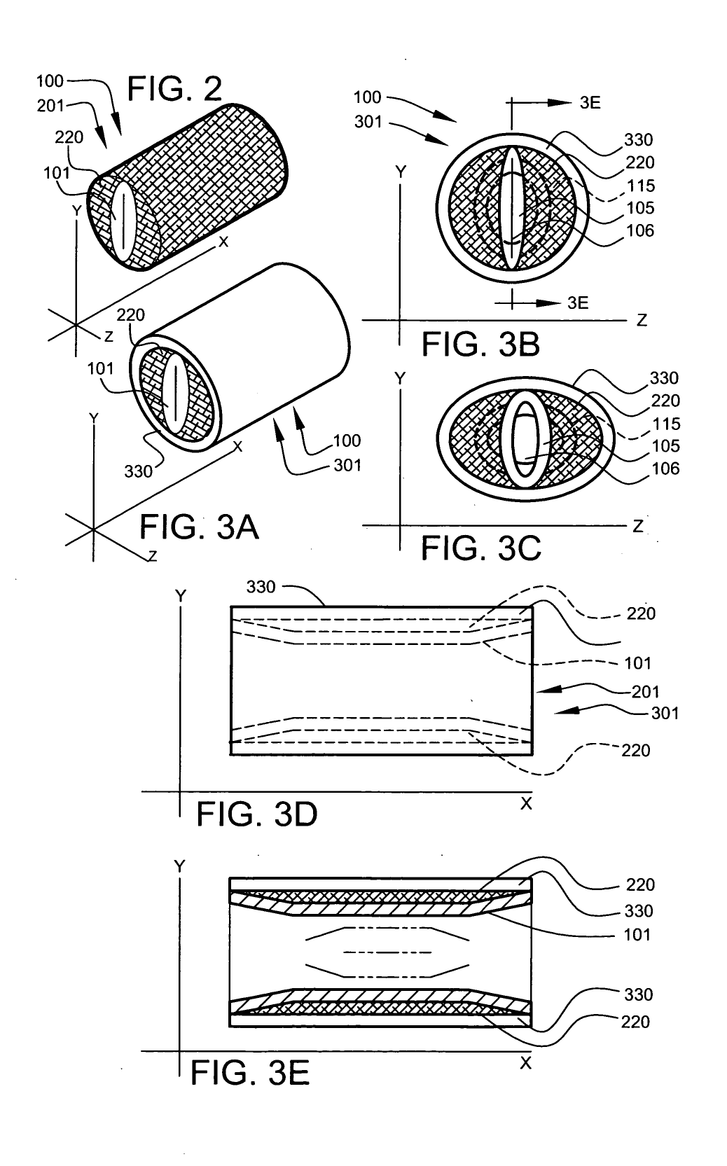

In a preferred alternate embodiment, double-check squeeze valve 101 is sized for use with larger or smaller conduits 330 (see FIG. 3A). Double-check squeeze valve 101 permits fluid flow to be stopped in both directions through conduit 330 when closed, and permits fluid to flow in either direction through conduit 330 when opened, with simple squeeze actuation and with a minimum of moving parts. Upon reading the teachings of this specification, those with ordinary skill in the art will now understand that, under appropriate circumstances, considering such issues as advances in technology, user preference, etc., other double-check squeeze valve uses, such as in industrial tubing or piping, in medical devices, in microfluidic devices, in hydraulics, as a backflow preventer, etc., may suffice.

FIG. 1D shows a side view of the preferred embodiment according to FIG. 1A. Preferably, double-check squeeze valve 101 is formed by crimping both ends of a tube, resulting in proximal end 105 (and first check valve 107) and distal end 110 (and second check valve 112) extending above and below squeeze portion 115 in the “Y” axis, as shown. Upon reading the teachings of this specification, those of ordinary skill in the art will now understand that, under appropriate circumstances, such as user preference, advances in technology, intended use, etc., other arrangements, such as proximal end and/or distal end being of equivalent height to the squeeze section, proximal end and/or distal end being narrower than the squeeze section, etc., may suffice.

FIG. 1E shows a sectional view of section 1E-1E of the preferred embodiment according to FIG. 1B. Preferably, double-check squeeze valve 101 comprises a hollow interior, as shown, to permit the free flow of fluid when double-check squeeze valve 101 is open (i.e., when both first check valve 107 and second check valve 112 are open). Upon reading the teachings of this specification, those of ordinary skill in the art will now understand that, under appropriate circumstances, such as user preference, advances in technology, intended use, etc., other arrangements, such as additional valves within the double-check squeeze valve, chemical coatings, such as soluble flavorings, within the valve, etc., may suffice.

FIG. 2 shows a perspective view of a leak-resistant drinking system comprising double-check squeeze valve 101 with resilient outer layer 220 according to a preferred embodiment of the present invention. Preferably, valve 201 comprises double-check squeeze valve 101 and resilient layer 220 (at least embodying herein first resilient closure means for resiliently closing such first check valve means, and at least embodying herein second resilient closure means for resiliently closing such second check valve means; and at least embodying herein at least one first resilient closure to resiliently close such at least one first check valve, and at least embodying herein at least one second resilient closure to resiliently close such at least one second check valve), as shown. Preferably, resilient layer 220 comprises a strong, resilient material having shape memory, such as, for example, foam rubber, as shown. Preferably, resilient layer 220 assists in holding double-check squeeze valve 101 in the closed position at rest, but does not add considerably to the force required to squeeze open valve 201 (i.e., valve 201 may still be easily opened by squeezing with the fingers, teeth, and/or lips of a user). Upon reading the teachings of this specification, those of ordinary skill in the art will now understand that, under appropriate circumstances, such as user preference, advances in technology, intended use, etc., other arrangements of resilient layer, such as other shapes, other materials (such as, for example, polyurethane foam, polyethylene foam, other plastic foams, silicone rubber, rubber), etc., may suffice.

FIG. 3A shows a perspective view of leak-resistant drinking system 100 comprising valve 201 housed in conduit 330 according to a preferred embodiment of the present invention. Preferably, valve 301 comprises the combination of valve 201 and conduit 330, as shown. Preferably, valve 201 fits sealably within conduit 330, as shown. Preferably, as shown, conduit 330 is not so tight against valve 201 that valve 201 is forced open. Preferably, conduit 330 comprises a strong, resilient material having shape memory, such as, for example, polyethylene plastic, as shown. Preferably, conduit 330 does not add considerably to the force required to squeeze open valve 301 (i.e., valve 301 may still be easily opened by squeezing with the fingers, teeth, and/or lips of a user). Upon reading the teachings of this specification, those of ordinary skill in the art will now understand that, under appropriate circumstances, such as user preference, advances in technology, intended use, etc., other materials, such as polyvinyl chloride, polypropylene, other plastics, silicone rubber, rubber, etc., may suffice.

FIG. 3B shows an end-on-view of the preferred embodiment according to FIG. 3A, in a closed position. Preferably, valve 301 is closed in the resting state, as shown. Preferably, squeeze portion 115 is squeezed when valve 301 is squeezed in the “Y” axis adjacent squeeze portion 115 (at least embodying herein wherein such double-check squeeze valve means is openable by at least one squeeze transmittable to such conduit means adjacent such double-check squeeze valve means; and at least embodying herein wherein such at least one double-check squeeze valve is openable by at least one squeeze transmittable to such at least one conduit adjacent such at least one double-check squeeze valve), as shown. Upon reading the teachings of this specification, those of ordinary skill in the art will now understand that, under appropriate circumstances, such as user preference, advances in technology, intended use, etc., other arrangements, such as squeeze section being flat in the resting state, proximal opening and/or distal opening comprising soft sealing materials, the conduit having another cross-sectional shape, etc., may suffice.

FIG. 3C shows an end-on view of the preferred embodiment according to FIG. 3A, in an open position. Preferably, squeezing valve 301 adjacent squeeze portion 115 in the squeeze axis (the “Y” axis, as shown) results in squeeze portion 115, resilient layer 220 (at least embodying herein resilient closure means for resiliently closing such double-check squeeze valve means; and at least embodying herein at least one resilient closure to resiliently close such at least one double-check squeeze valve), and conduit 330 becoming wider in the “Z” axis and proximal opening 106 and distal opening 111 opening from the closed position, as shown. Preferably, the width of proximal opening 106 and distal opening 111 is dependent on the amount of squeeze pressure applied to squeeze portion 115. Preferably, when valve 301 is in an open position (i.e. when both first check valve 107 and second check valve 112 are open), fluid may flow through valve 301. Upon reading the teachings of this specification, those of ordinary skill in the art will now understand that, under appropriate circumstances, such as user preference, advances in technology, intended use, etc., other arrangements, such as proximal opening and distal opening opening fully with little dependence on the pressure applied, etc., may suffice.

FIG. 3D shows a side view of the preferred embodiment according to FIG. 3A. Preferably, valve 201 fits sealably within conduit 330 (at least embodying herein wherein such double-check squeeze valve means is housed within such conduit means; and at least embodying herein wherein such at least one double-check squeeze valve is housed within such at least one conduit), as shown, so that fluid cannot bypass valve 201. Upon reading the teachings of this specification, those of ordinary skill in the art will now understand that, under appropriate circumstances, such as user preference, advances in technology, intended use, etc., other arrangements, such as multiple valves fitting side-by-side within the conduit, etc., may suffice.

FIG. 3E shows a sectional view of section 3E-3E of the preferred embodiment according to FIG. 3B. Preferably, valve 301 comprises a hollow interior, as shown, to permit the free flow of fluid when valve 301 is open. Upon reading the teachings of this specification, those of ordinary skill in the art will now understand that, under appropriate circumstances, such as user preference, advances in technology, intended use, etc., other arrangements, such as additional valves within the valve, chemical coatings, such as soluble flavorings, within the valve, etc., may suffice.

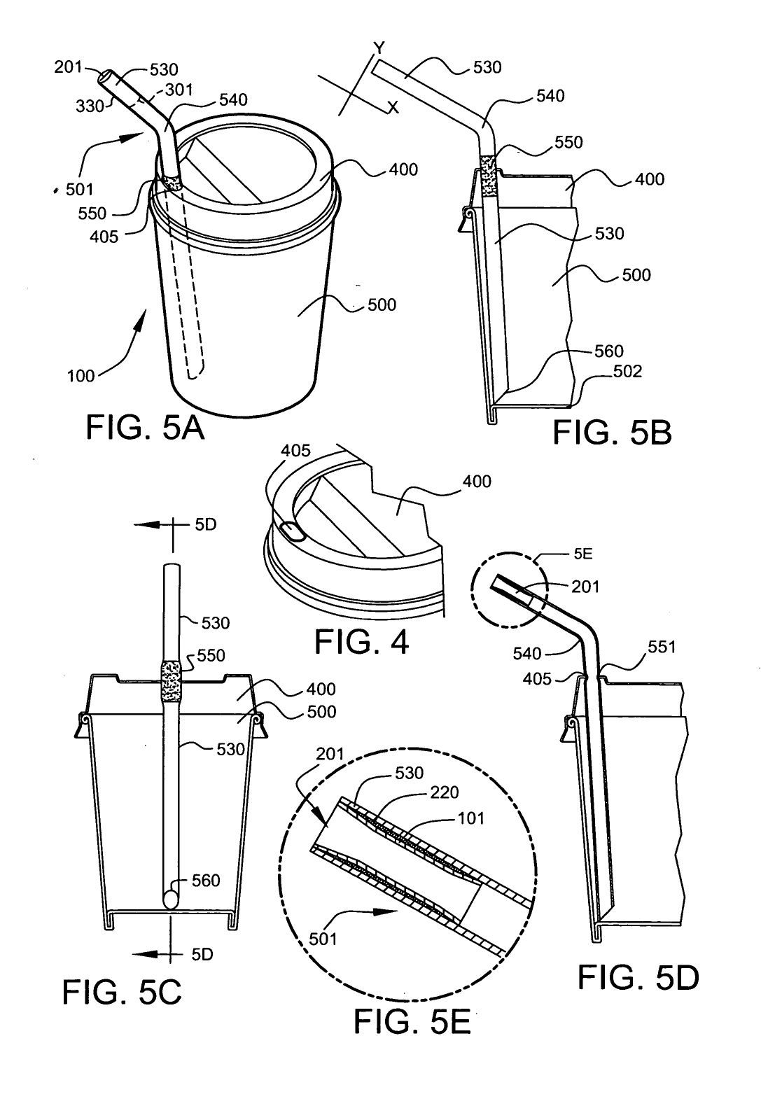

FIG. 4 shows a perspective view of domed-sip cup lid 400 according to a preferred embodiment of the present invention. Preferably, domed-sip cup lid 400 is of a standard size and fits a standard cup, as shown especially in FIG. 5A and FIG. 5C. Preferably, domed-sip cup lid 400 comprises racetrack aperture 405, as shown that is preferably about twenty-five millimeters in circumference. Upon reading the teachings of this specification, those of ordinary skill in the art will now understand that, under appropriate circumstances, such as user preference, advances in technology, intended use, etc., other cup lids, such as flat cup lids, cup lids having apertures of other shapes and/or circumferences, etc., may suffice.

FIG. 5A shows a perspective view of leak-resistant drinking system 100 according to a preferred embodiment of the present invention. Preferably, leak-resistant drinking system 100 comprises valve 501, as shown. Preferably, leak-resistant drinking system 100 further comprises domed-sip cup lid 400 and cup 500, as shown. Preferably, domed-sip cup lid 400 is placed on cup 500, as shown. Preferably, valve 501 is inserted into cup 500 through racetrack aperture 405 on domed-sip cup lid 400, as shown. Upon reading the teachings of this specification, those of ordinary skill in the art will now understand that, under appropriate circumstances, such as user preference, advances in technology, intended use, etc., other arrangements, such as inserting the valve into the cup through a different aperture, etc., may suffice.

Preferably, valve 501 comprises valve 301 (at least embodying herein double-check squeeze valve means for double-check squeeze valve control of the flow of the fluid through such conduit means; and at least embodying herein at least one double-check squeeze valve to double-check squeeze valve control the flow of the at least one fluid through such at least one conduit), wherein conduit 330 comprises drinking straw 530, as shown. Preferably, valve 201 is held within drinking straw 530 in a fixed “Y” axis orientation, as shown. Preferably, drinking straw 530 (at least embodying herein wherein at least one outside circumference of such conduit means substantially comprises at least one inside circumference of such conduit aperture means; and at least embodying herein wherein at least one outside circumference of such at least one conduit substantially comprises at least one inside circumference of such at least one conduit aperture) is sized to sealably fit racetrack aperture 405, as shown. Upon reading the teachings of this specification, those of ordinary skill in the art will now understand that, under appropriate circumstances, such as user preference, advances in technology, intended use, etc., other arrangements, such as a drinking straw loosely fitting the racetrack aperture, etc., may suffice.

Preferably, drinking straw 530 comprises orienting bend 540, as shown. Orienting bend 540 (at least embodying herein wherein such conduit means comprises positioner means for positioning such double-check squeeze valve means in a correct orientation relative to at least one user; and at least embodying herein wherein such at least one conduit comprises at least one positioner to position such at least one double-check squeeze valve in a correct orientation relative to at least one user) preferably comprises a permanent angle, and preferably lies in the same “Y” axis as valve 201, as shown. Preferably, orienting bend 540 causes valve 201 to be presented to the user in the correct orientation to be opened by pressure from the teeth and/or lips (i.e., the squeeze axis of valve 501 is vertical with respect to the user). Upon reading the teachings of this specification, those of ordinary skill in the art will now understand that, under appropriate circumstances, such as user preference, advances in technology, intended use, etc., other arrangements, such as no orienting bend, multiple orienting bends, other bend angles, etc., may suffice.

Preferably, valve 501 comprises valve positioner 550, as shown. Preferably, valve positioner 550 holds valve 501 at a certain position relative to racetrack aperture 405, as shown. More preferably, valve positioner 550 holds valve 501 fully inserted into cup 500, as shown. Preferably, valve positioner 550 comprises a coating of soft, adhesive material, such as, for example, soft rubber, as shown. Preferably, valve positioner 550 also serves to help seal drinking straw 530 against racetrack aperture 405, as shown. Upon reading the teachings of this specification, those of ordinary skill in the art will now understand that, under appropriate circumstances, such as user preference, advances in technology, intended use, etc., other valve positioner materials, such as silicone rubber, other adhesive, silly putty, rubber, etc., may suffice.

FIG. 5B shows a side view of the leak-resistant drinking system 100 according to FIG. 5A. Preferably, drinking straw 530 comprises tapered end 560, as shown. Preferably, tapered end 560 assists users in inserting the distal end of valve 501 into racetrack aperture 405. Preferably, tapered end 560 (at least embodying herein wherein such conduit means comprises tapered distal end means for tapering at least one distal end of such conduit means; and at least embodying herein wherein such at least one conduit comprises at least one tapered distal end to taper at least one distal end of such at least one conduit) also helps prevent valve 501 from becoming sealed against cup bottom 502 when valve 501 is fully inserted into cup 500, as shown. Upon reading the teachings of this specification, those of ordinary skill in the art will now understand that, under appropriate circumstances, such as user preference, advances in technology, intended use, etc., other valve ends, such as slit ends, flat ends, spoon ends, etc., may suffice.

FIG. 5C shows a front view of the leak-resistant drinking system according to FIG. 5A. Preferably, drinking straw 530 has substantially the same diameter along its entire length, as shown. Upon reading the teachings of this specification, those of ordinary skill in the art will now understand that, under appropriate circumstances, such as user preference, advances in technology, intended use, etc., other drinking straw diameter arrangements, such as widening where the valve intersects the racetrack aperture, widening where the valve contains the double-check valve, etc., may suffice.

FIG. 5D shows a sectional view of section 5D-5D of the leak-resistant drinking system according to FIG. 5C. FIG. 5D clearly shows how orienting bend 540 is preferably in the same axis as the “Y” axis of valve 201, as shown. Also, an alternate embodiment of valve positioner 550 (at least embodying herein wherein such conduit means comprises positioner means for positioning such double-check squeeze valve means relative to such conduit aperture means; and at least embodying herein wherein such at least one conduit comprises at least one positioner to position such at least one double-check squeeze valve relative to such at least one conduit aperture) is shown, comprising notch 551 in drinking straw 530, as shown. Preferably, notch 551 engages racetrack aperture 405 around substantially the entire circumference of racetrack aperture 405 to hold valve 501 in a fixed position relative to racetrack aperture 405, as shown. More preferably, notch 551 pressure sealably engages racetrack aperture 405, as shown. Upon reading the teachings of this specification, those of ordinary skill in the art will now understand that, under appropriate circumstances, such as user preference, advances in technology, intended use, etc., other arrangements, such as a notch that partially engages the racetrack aperture, multiple notches at multiple depths, etc., may suffice.

FIG. 5E shows an enlargement of section 5E of leak-resistant drinking system 100 according to FIG. 5D. Preferably, valve 201 is fixed within drinking straw 530 by such means as, for example, friction, as shown. Upon reading the teachings of this specification, those of ordinary skill in the art will now understand that, under appropriate circumstances, such as user preference, advances in technology, intended use, etc., other means for fixing the double-check valve within a conduit, such as ultrasonic welding, adhesive, melt welding, crimping the conduit, etc., may suffice.

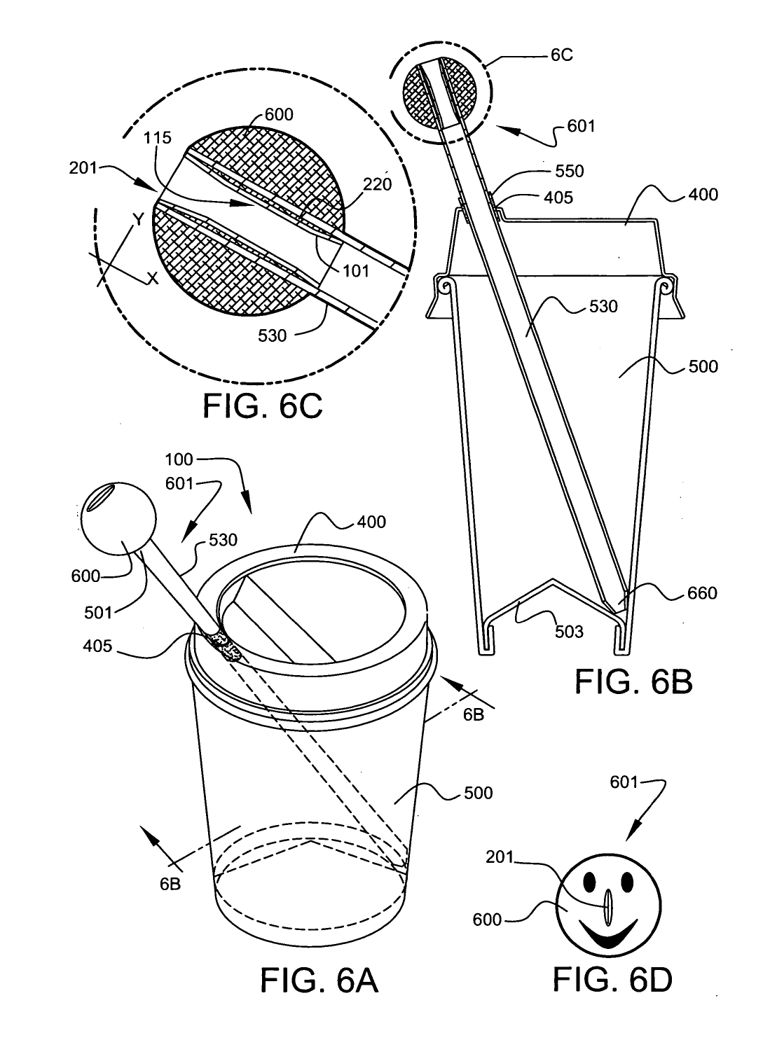

FIG. 6A shows a perspective view of leak-resistant drinking system 100 according to a preferred embodiment of the present invention. Preferably, leak-resistant drinking system 100 comprises valve 601, as shown. Preferably, valve 601 comprises valve 501 and cushion 600, as shown. Preferably, cushion 600 comprises a soft, resilient material having shape memory, such as, for example, foam rubber, as shown. Preferably, cushion 600 helps to prevent drinking straw 530 from poking users, especially in the eye, especially where the users are children. Preferably, valve 601 is used by squeezing cushion 600 adjacent squeeze section 115 (see FIG. 6C) until squeeze section 115 is compressed sufficiently to open first check valve 107 (at least embodying herein first check valve means for valving the forward flow of fluid, and at least embodying herein first check valve means for valving the flow of fluid; and at least embodying herein at least one first check valve to valve the forward flow of at least one fluid, and at least embodying herein at least one first check valve to valve the flow of at least one fluid), and second check valve 112 (at least embodying herein second check valve means for valving the backward flow of fluid, and at least embodying herein second check valve means for valving the flow of fluid; and at least embodying herein at least one second check valve to valve the backward flow of at least one fluid, and at least embodying herein at least one second check valve to valve the flow of at least one fluid), as shown. Preferably, cushion 600 does not add considerably to the force required to squeeze open valve 601 (i.e., valve 601 may still be easily opened by squeezing with the fingers, teeth, and/or lips of a user). Upon reading the teachings of this specification, those of ordinary skill in the art will now understand that, under appropriate circumstances, such as user preference, advances in technology, intended use, etc., other materials, such as silicone rubber, polyurethane foam, rubber, etc., may suffice.

FIG. 6B shows a sectional view of section 6B-6B of leak-resistant drinking system 100 according to FIG. 6A. Preferably, cup 500 comprises sump bottom 503, as shown. Preferably, sump bottom 503 directs fluid toward the distal end of valve 601 and assists users in drinking the entire contents of cup 500, especially where valve 601 is held in a fixed position, as shown. Preferably, drinking straw 530 comprises truncated tapered end 660, as shown. Preferably, truncated tapered end 660 assists users in inserting valve 601 into racetrack aperture 405. Preferably, truncated tapered end 660 also helps prevent valve 601 from becoming sealed against sump bottom 503, as shown. Upon reading the teachings of this specification, those of ordinary skill in the art will now understand that, under appropriate circumstances, such as user preference, advances in technology, intended use, etc., other valve ends, such as slit ends, flat ends, spoon ends, etc., may suffice.

FIG. 6C shows an enlargement of section 6C of leak-resistant drinking system 100 according to FIG. 6B. Preferably, cushion 600 extends along drinking straw 530 substantially the same distance as valve 201, as shown, in order to provide comfortable use, and in order to assist users in locating squeeze portion 115. Preferably, for the comfort of the user, cushion 600 of valve 601 comprises at least one substantially curved sectional profile. Upon reading the teachings of this specification, those of ordinary skill in the art will now understand that, under appropriate circumstances, such as user preference, advances in technology, intended use, etc., other arrangements, such as the cushion being shorter or longer than the valve, the cushion having indicia or shaping indicating the location of the squeeze portion, etc., may suffice.

FIG. 6D shows a front view of indicia on leak-resistant drinking system 100 according to FIG. 6A. Preferably, cushion 600 comprises indicia, such as, for example, a happy face, as shown. Upon reading the teachings of this specification, those of ordinary skill in the art will now understand that, under appropriate circumstances, such as user preference, advances in technology, intended use, etc., other indicia, such as words, pictures, colors, etc., may suffice.

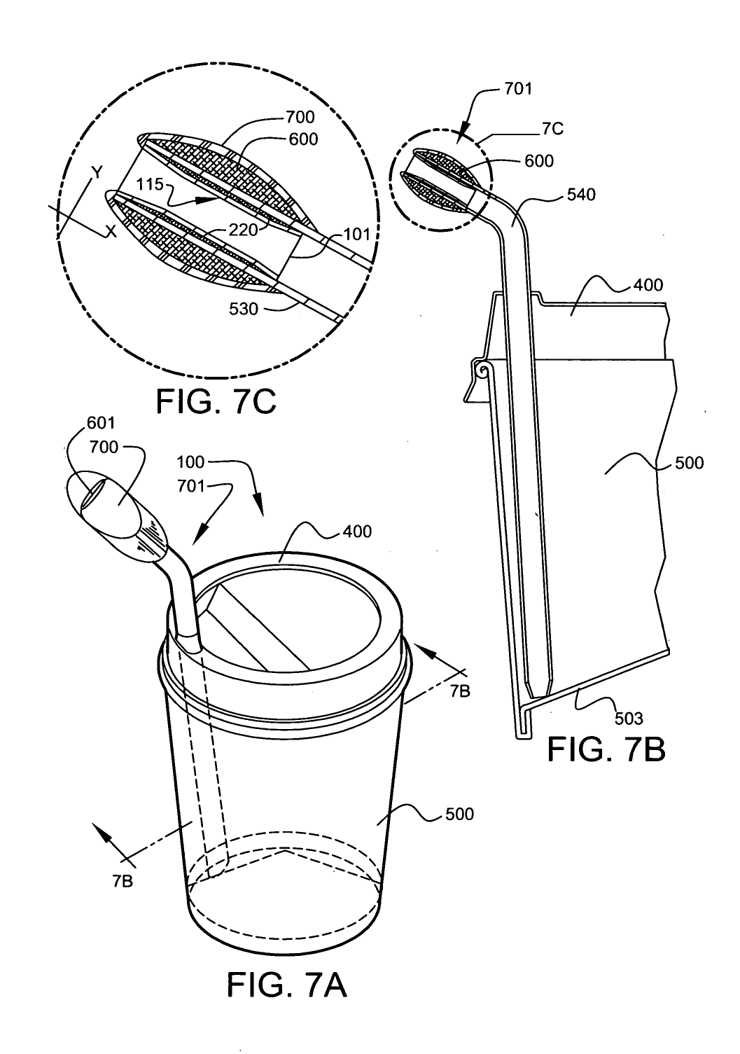

FIG. 7A shows a perspective view of a leak-resistant drinking system according to a preferred embodiment of the present invention. Preferably, leak-resistant drinking system 100 comprises valve 701, as shown. Preferably, valve 701 comprises a combination of valve 601 and coating 700, as shown. Preferably, coating 700 comprises a soft, resilient, water-impermeable material having shape memory, such as, for example, rubber, as shown. Preferably, coating 700 serves to seal and reinforce cushion 600 (see FIG. 7C), especially where cushion 600 is porous and/or easily bitten through, such as where cushion 600 comprises foam rubber, as shown. Preferably, coating 700 does not add considerably to the force required to squeeze open valve 701 (i.e., valve 701 may still be easily opened by squeezing with the fingers, teeth, and/or lips of a user). Upon reading the teachings of this specification, those of ordinary skill in the art will now understand that, under appropriate circumstances, such as user preference, advances in technology, intended use, etc., other materials, such as silicone rubber, polyurethane, polyethylene, soft plastic, etc., may suffice.

FIG. 7B shows a sectional view of section 7B-7B of leak-resistant drinking system 100 according to FIG. 7A. Preferably, for the comfort of the user, cushion 600 of valve 701 comprises at least one substantially curved sectional profile. Cushion 600 is here shown in an alternate shape, being curved in the “X” axis, and being wider in the “Z” axis than in the “Y” axis, to provide an oblate shape that is comfortable for the user, and that assists in aligning the bite of the user with the squeeze axis (the “Y” axis, as shown) of valve 701. Upon reading the teachings of this specification, those of ordinary skill in the art will now understand that, under appropriate circumstances, such as user preference, advances in technology, intended use, etc., other cushion shapes, such as novelty, cubic, cylindrical, flattened, pyramidal, toroidal, etc., may suffice.

FIG. 7C shows an enlargement of section 7C of leak-resistant drinking system 100 according to FIG. 7B. Preferably, coating 700 (at least embodying herein resilient coating means for resiliently coating such cushion means; and at least embodying herein at least one resilient coating to resiliently coat such at least one cushion) completely covers and seals cushion 600, as shown. Preferably, coating 700 extends past cushion 600 slightly onto drinking straw 530, in order to seal the edges of cushion 600 (at least embodying herein cushion means for cushioning such conduit means; and at least embodying herein at least one cushion to cushion such at least one conduit), as shown. Upon reading the teachings of this specification, those of ordinary skill in the art will now understand that, under appropriate circumstances, such as user preference, advances in technology, intended use, etc., other arrangements, such as the coating only partially covering the cushion, the coating comprising indicia, the coating covering a large portion or all of the drinking straw, etc., may suffice.

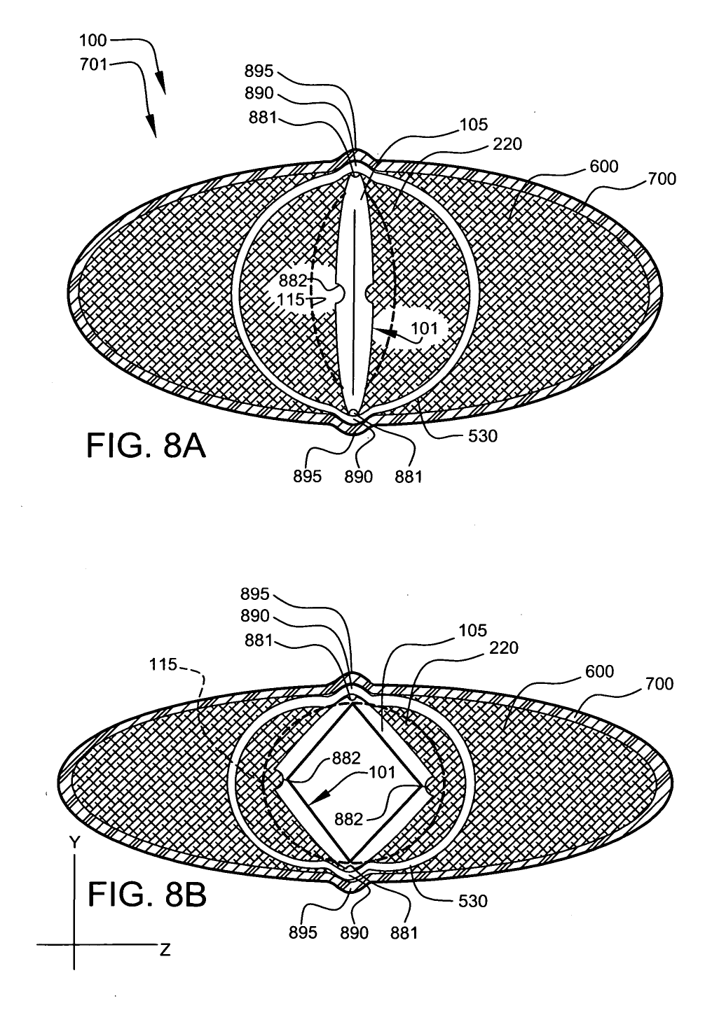

FIG. 8A shows a front view of one preferred variation of the preferred embodiment of the present invention according to FIG. 7A, in the closed position. Preferably, double-check squeeze valve 101 further comprises vertical valve hinges 881 and/or horizontal valve hinges 882 (at least embodying herein wherein such double-check squeeze valve means comprises valve hinge means for assisting opening of such double-check squeeze valve means; and at least embodying herein wherein such at least one double-check squeeze valve comprises at least one valve hinge to assisting opening of such at least one double-check squeeze valve), as shown. Preferably, vertical valve hinges 881 and/or horizontal valve hinges 882 assist opening double-check squeeze valve 101 by providing low-pressure bendable hinges. Preferably, vertical valve hinges 881 and horizontal valve hinges 882 extend at least partially along the length of double-check squeeze valve 101 in the “X” axis. Preferably, vertical valve hinges 881 and horizontal valve hinges 882 extend at least partially along proximal end 105 and distal end 110 of double-check squeeze valve 101 (at least embodying herein wherein such first check valve means comprises first valve hinge means for assisting opening of such first check valve means, and at least embodying herein wherein such second check valve means comprises second valve hinge means for assisting opening of such second check valve means; and at least embodying herein wherein such at least one first check valve comprises at least one first valve hinge to assist opening of such at least one first check valve, and at least embodying herein wherein such at least one second check valve comprises at least one second valve hinge to assist opening of such at least one second check valve). Upon reading the teachings of this specification, those of ordinary skill in the art will now understand that, under appropriate circumstances, such as user preference, advances in technology, intended use, etc., other arrangements, such as vertical and horizontal valve hinges having different lengths, either vertical valve hinges or vertical valve hinges being absent, etc., may suffice.

Preferably, drinking straw 530 comprises valve holders 890, as shown. Preferably, valve holders 890 (at least embodying herein wherein such conduit means comprises valve holder means for holding such double-check squeeze valve means within such conduit means; and at least embodying herein wherein such at least one conduit comprises at least one valve holder to hold such at least one double-check squeeze valve within such at least one conduit) comprise notches along the “X” axis of drinking straw 530 that serve to hold double-check squeeze valve 101 in the proper “Y” axis alignment, as shown. Preferably, valve holders 890 extend from the proximal end of drinking straw 530 at least to distal end 110 of double-check squeeze valve 101, as shown. Upon reading the teachings of this specification, those of ordinary skill in the art will now understand that, under appropriate circumstances, such as user preference, advances in technology, intended use, etc., other valve holders, such as shorter notches, an oval drinking straw, adhesive, welds, etc., may suffice.

Preferably, coating 700 comprises conduit holders 895, as shown. Preferably, conduit holders 895 comprise notches along the “X” axis of coating 700 that serve to hold conduit 330 (i.e. drinking straw 530) in the proper “Y” axis alignment, as shown. Preferably, conduit holders 895 (at least embodying herein conduit holder means for holding such conduit means within such resilient coating means; and at least embodying herein at least one conduit holder to hold such at least one conduit within such at least one resilient coating) extend from the proximal end of drinking straw 530 to the distal end of coating 700. Upon reading the teachings of this specification, those of ordinary skill in the art will now understand that, under appropriate circumstances, such as user preference, advances in technology, intended use, etc., other conduit holders, such as shorter notches, other shapes, adhesive, welds, etc., may suffice.

FIG. 8B shows a front view of the preferred embodiment according to FIG. 8A, in an open position. Preferably, vertical valve hinges 881 and/or horizontal valve hinges 882 reduce the amount of force required to open double-check squeeze valve 101. Preferably, valve 701 is opened when a user places valve 701 between the user's teeth (or lips, gums, fingers, etc.) and squeezes down on valve 701 adjacent squeeze portion 115 (at least embodying herein squeeze opener means for squeezing open such first check valve means and such second check valve means simultaneously; and at least embodying herein at least one squeeze opener to squeeze open such at least one first check valve and such at least one second check valve simultaneously), in the “Y” axis of valve 701, as shown. Preferably, the user draws fluid through valve 701 while keeping valve 701 squeezed into an open position. Upon reading the teachings of this specification, those of ordinary skill in the art will now understand that, under appropriate circumstances, such as user preference, advances in technology, intended use, etc., other methods of squeezing the valve, such as with a clamp, by bending, etc., may suffice.

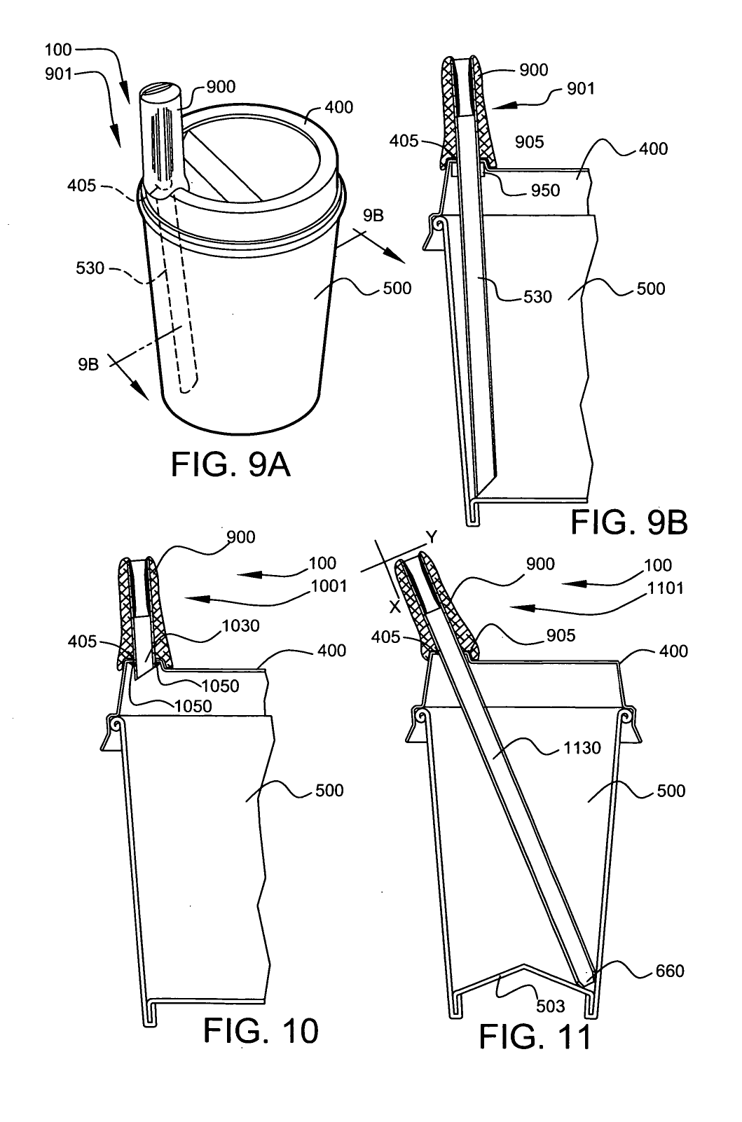

FIG. 9A shows a perspective view of leak-resistant drinking system 100 according to a preferred embodiment of the present invention. Preferably, leak-resistant drinking system 100 comprises valve 901, as shown. Preferably, valve 901 is a variation of valve 601, valve 701, and/or valve 801 wherein cushion 600 comprises cushion 900 that extends from the proximal end of drinking straw 530 to cover and seal racetrack aperture 405, as shown. Upon reading the teachings of this specification, those of ordinary skill in the art will now understand that, under appropriate circumstances, such as user preference, advances in technology, intended use, etc., other arrangements, such as where the cushion covers and seals at least a large portion of the dome-sip cup lid, etc., may suffice.

FIG. 9B shows a sectional view of section 9B-9B of leak-resistant drinking system 100 according to FIG. 9A. Preferably, cushion 900 is permanently sealably attached to drinking straw 530, as shown. Preferably, cushion 900 is permanently attached to dome-sip cup lid 400 with adhesive 905, as shown. Preferably, adhesive 905 assists cushion 900 to make a durable leak-resistant seal around racetrack aperture 405, as shown. Upon reading the teachings of this specification, those of ordinary skill in the art will now understand that, under appropriate circumstances, such as user preference, advances in technology, intended use, etc., other drip-resistant seals, such as welds, pressure seals, etc., may suffice.

Valve 901 also illustrates another preferred embodiment of valve positioner 550 (of FIG. 5A), comprising valve positioner 950, comprising a resilient ring positionable along the length of drinking straw 530 inside dome-sip cup lid 400, as shown. Preferably, valve positioner 950 comprises a resilient material such as, for example, rubber, as shown. Preferably, valve positioner 950 holds valve 901 with cushion 900 sealably compressed against racetrack aperture 405, as shown. Preferably, valve positioner 950 also assists sealing racetrack aperture 405, as shown. Upon reading the teachings of this specification, those of ordinary skill in the art will now understand that, under appropriate circumstances, such as user preference, advances in technology, intended use, etc., other arrangements, such as multiple valve positioners, other materials such as silicone rubber, soft plastic, etc., may suffice.

FIG. 10 shows a perspective view of leak-resistant drinking system 100 according to a preferred embodiment of the present invention. Preferably, valve 1001 is a variation of valve 901 wherein drinking straw 530 comprises conduit 1030, as shown, that is preferably short enough to permit a user to tip cup 500 to drink. Upon reading the teachings of this specification, those of ordinary skill in the art will now understand that, under appropriate circumstances, such as user preference, advances in technology, intended use, etc., other conduits, such as flexible conduits, curved conduits, etc., may suffice.

Valve 1001 also illustrates another preferred embodiment of valve positioner 550, comprising valve positioner 1050, comprising ridges that engage racetrack aperture 405, as shown. Preferably, valve positioner 1050 holds valve 1001 with cushion 900 sealably compressed against racetrack aperture 405 (at least embodying herein conduit aperture means for passing such conduit means through such cup lid means; and at least embodying herein at least one conduit aperture to pass such at least one conduit through such at least one cup lid), as shown. Preferably, valve positioner 1050 also assists sealing racetrack aperture 405, as shown. Upon reading the teachings of this specification, those of ordinary skill in the art will now understand that, under appropriate circumstances, such as user preference, advances in technology, intended use, etc., other arrangements, such as multiple ridges, partial ridges, barbs, etc., may suffice.

FIG. 11 shows a perspective view of leak-resistant drinking system 100 according to a preferred embodiment of the present invention. Preferably, valve 1101 is a variation of valve 901 wherein drinking straw 530 comprises conduit 1130, as shown, that is preferably the correct length to engage sump bottom 503 on the far side of cup 500, as shown. Preferably, conduit 1130 comprises truncated tapered end 660, as shown. Preferably, truncated tapered end 660 (at least embodying herein wherein such conduit means comprises truncated tapered distal end means for tapering at least one truncated distal end of such conduit means; and at least embodying herein wherein such at least one conduit comprises at least one truncated tapered distal end to taper at least one truncated distal end of such at least one conduit) will not seal against cup 500 and sump bottom 503 (at least embodying herein wherein such cup means comprises sump means for collecting fluid in at least one bottom of such cup means; at least embodying herein wherein such at least one cup comprises at least one sump to collect at least one fluid in at least one bottom of such at least one cup), as shown. Upon reading the teachings of this specification, those of ordinary skill in the art will now understand that, under appropriate circumstances, such as user preference, advances in technology, intended use, etc., other valves, such as such as valves having other combinations of check valves, cushions, coatings, valve positioners, conduit ends, conduits, conduit holders, valve hinges, resilient layers, valve holders, cups, cup lids, cup bottoms, etc., may suffice.

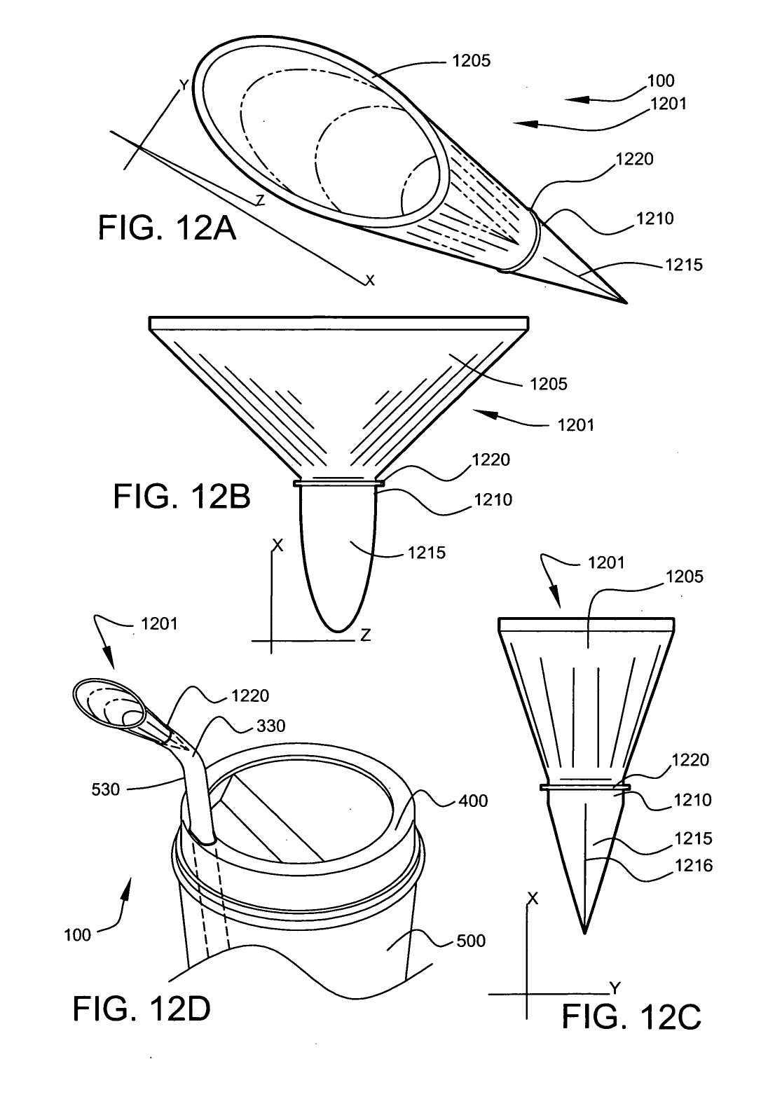

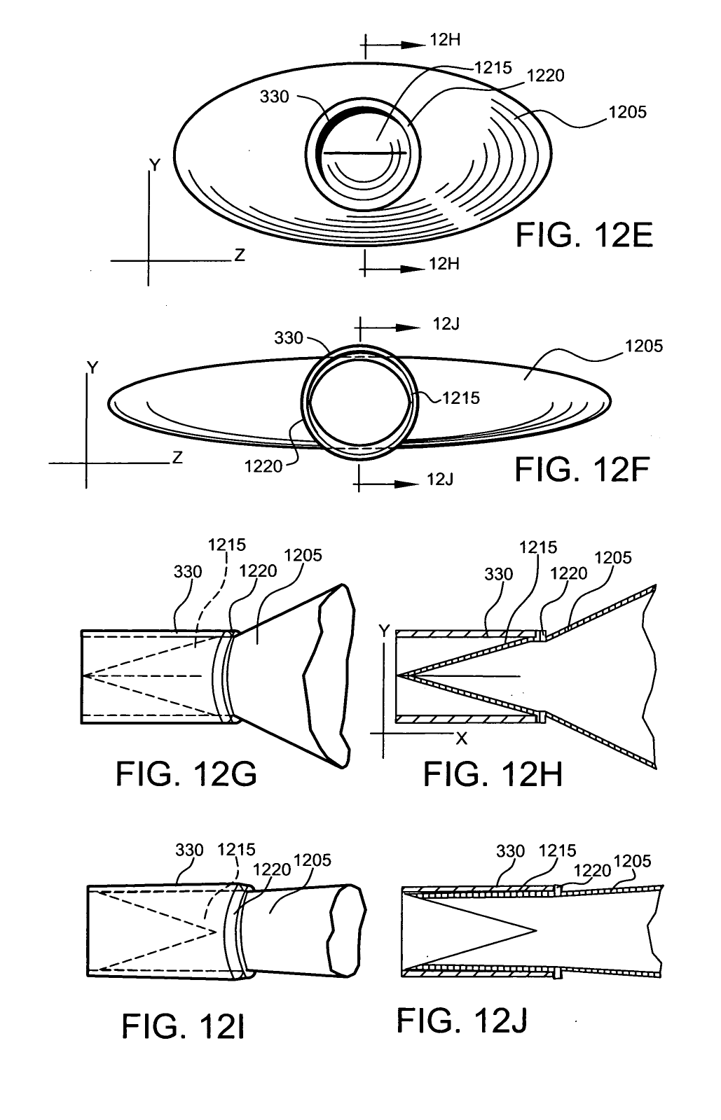

FIG. 12A shows a perspective view of leak-resistant drinking system 100 comprising duckbill valve 1201 according to a preferred embodiment of the present invention. Preferably, leak-resistant drinking system 100 comprises valve 1201, as shown. Preferably, valve 1201 comprises bite funnel 1205, seal portion 1210, and duckbill valve 1215, as shown. Preferably, valve 1201 is made from a single piece of resilient material having shape memory, such as, for example, polyethylene, as shown. Preferably, squeezing bite funnel 1205 in the “Y” axis opens duckbill valve 1215, as shown. Preferably, valve 1201 comprises conduit stop 1220 that stops valve 1201 at the correct insertion point into conduit 330, as shown in FIG. 12D. Upon reading the teachings of this specification, those of ordinary skill in the art will now understand that, under appropriate circumstances, such as user preference, advances in technology, intended use, etc., other arrangements, such as other materials (such as rubber, silicone rubber, other plastics, etc.), other components (such as additional valves), etc., may suffice.

FIG. 12B shows a top plan view of the preferred embodiment according to FIG. 12A. Preferably, duckbill valve 1215 is sized to fit within conduit 330, as shown, such as, for example, drinking straw 530, as shown. Preferably, duckbill valve 1215 is between about one quarter of an inch and about one inch long in the “X” axis. Preferably, seal portion 1210 is sized and shaped to sealably engage conduit 330 when duckbill valve 1215 is inserted into conduit 330, as shown. Preferably, seal portion 1210 (at least embodying herein wherein such duckbill seal means is between such duckbill valve means and such duckbill opener means; and at least embodying herein wherein such at least one duckbill seal is between such at least one duckbill valve and such at least one duckbill opener) connects bite funnel 1205 and duckbill valve 1215, as shown. Preferably, seal portion 1210 (at least embodying herein duckbill seal means for sealably engaging the at least one conduit; and at least embodying herein at least one duckbill seal to sealably engage the at least one conduit) is short enough in the “X” axis to permit the deformation caused by squeezing bite funnel 1205 to open duckbill valve 1215, and is long enough in the “X” axis to provide an effective seal against conduit 330, as shown, such as, for example, between about one eighth inch and about one half of an inch. Preferably, bite funnel 1205 is sized to fit conveniently between the teeth of a user, before being squeezed, such as, for example about one and one half inches wide in the “Z” axis and about one inch tall in the “Y” axis. Upon reading the teachings of this specification, those of ordinary skill in the art will now understand that, under appropriate circumstances, such as user preference, advances in technology, intended use, etc., other sizes, such as a larger or smaller bite funnel, a longer or shorter seal portion, longer or shorter duckbill valve, etc., may suffice.

FIG. 12C shows a side view of the preferred embodiment according to FIG. 12A. Preferably, duckbill valve 1215 comprises horizontal slit 1216 in the “X” axis, as shown, that permits duckbill valve 1215 to open when deformed by “Y” axis pressure on bite funnel 1205, as shown. Upon reading the teachings of this specification, those of ordinary skill in the art will now understand that, under appropriate circumstances, such as user preference, advances in technology, intended use, etc., other duckbill valve arrangements, such as additional “Y” axis slits, rigid pivot portions between the bite funnel and the duckbill valve, additional layers, indicia, etc., may suffice.

FIG. 12D shows a perspective view of the preferred embodiment according to FIG. 12A, in use. Preferably, valve 1201 is inserted into conduit 330, such as drinking straw 530, up to the depth defined by conduit stop 1220, as shown. Preferably, valve 1201 pressure sealably engages conduit 330, as shown. Preferably, conduit stop 1220 (at least embodying herein wherein such duckbill seal means further comprises stop means for stopping such duckbill squeeze valve means relative to the at least one conduit; and at least embodying herein wherein such at least one duckbill seal further comprises at least one stop to stop such at least one duckbill squeeze valve relative to the at least one conduit) assists in sealing valve 1201 against conduit 330, as shown. Preferably, in order to drink, the user bites bite funnel 1205 (at least embodying herein wherein squeezing of such duckbill opener means is operable to open such duckbill valve means; and at least embodying herein wherein squeezing of such at least one duckbill opener is operable to open such at least one duckbill valve), opening duckbill valve 1215, and draws fluid through valve 1201 through conduit 330. Upon reading the teachings of this specification, those of ordinary skill in the art will now understand that, under appropriate circumstances, such as user preference, advances in technology, intended use, etc., other arrangements, such as inserting the valve directly into a fluid container at another point, not having a conduit stop, etc., may suffice.

FIG. 12E shows a front view of the preferred embodiment according to FIG. 12A, in the closed position. Preferably, bite funnel 1205 (at least embodying herein duckbill opener means for opening such duckbill valve means; and at least embodying herein at least one duckbill opener to open such at least one duckbill valve) is open and duckbill valve 1215 (at least embodying herein duckbill valve means for duckbill valving the flow of fluid through the at least one conduit; and at least embodying herein at least one duckbill valve to duckbill valve the flow of at least one fluid through the at least one conduit) is sealed closed in the resting state, as shown. Preferably, conduit 330 assists slightly in holding duckbill valve 1215 in the closed position in the resting state, as shown. Upon reading the teachings of this specification, those of ordinary skill in the art will now understand that, under appropriate circumstances, such as user preference, advances in technology, intended use, etc., other arrangements, such as having a resilient layer assisting in holding the duckbill valve closed, etc., may suffice.

FIG. 12F shows a front view of the preferred embodiment according to FIG. 12A, in an open position. Preferably, valve 1201 remains sealed against conduit 330 when compressed, as shown. Upon reading the teachings of this specification, those of ordinary skill in the art will now understand that, under appropriate circumstances, such as user preference, advances in technology, intended use, etc., other seals, such as adhesive, welds, notches, etc., may suffice.

FIG. 12G shows a side view of the preferred embodiment according to FIG. 12A, inserted into conduit 330, in the closed position.

FIG. 12H shows a sectional view of section 12H-12H of FIG. 12E, inserted into conduit 330, in the closed position.

FIG. 12I shows a side view of the preferred embodiment according to FIG. 12A, inserted into conduit 330, in the open position. Preferably, opening duckbill valve 1215 deforms conduit 330 slightly, as shown. Upon reading the teachings of this specification, those of ordinary skill in the art will now understand that, under appropriate circumstances, such as user preference, advances in technology, intended use, etc., other arrangements, such as the conduit deforming significantly, the conduit comprising a very elastic material such as rubber, an elastic conduit connecting the valve to another rigid drinking straw or conduit, etc., may suffice.

FIG. 12J shows a sectional view of section 12J-12J of FIG. 12F, inserted into conduit 330, in the open position.

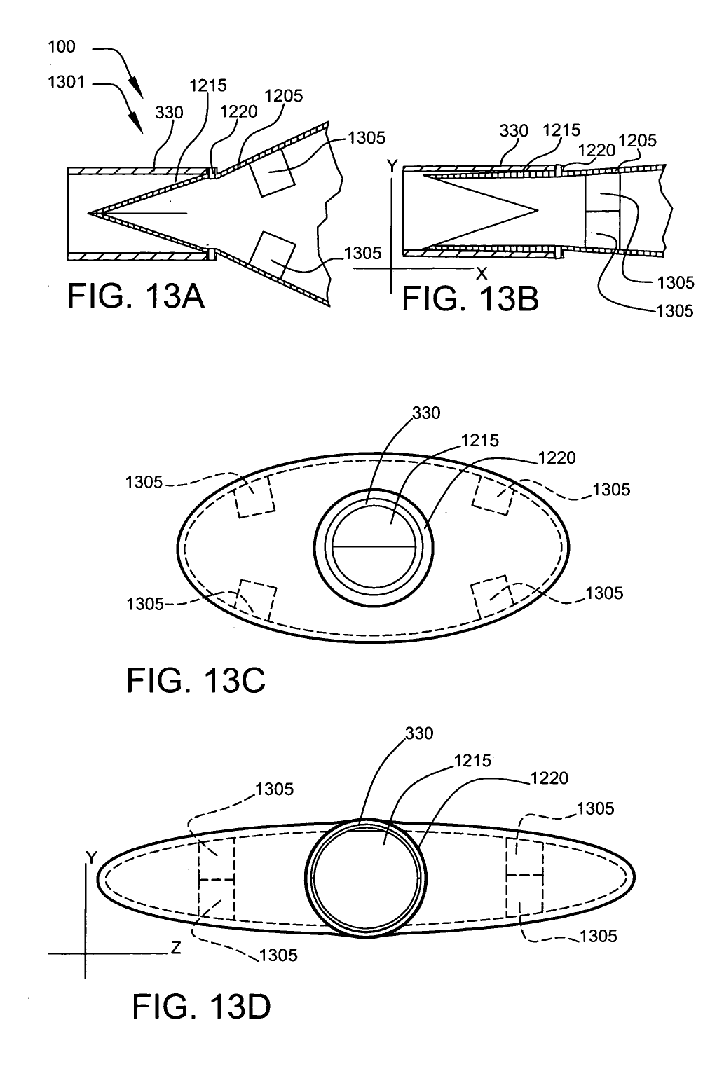

FIG. 13A shows a sectional view of leak-resistant drinking system 100 according to a preferred embodiment of the present invention, in the closed position. Preferably, valve 1301 comprises valve 1201 and bite stops 1305, as shown. Preferably, bite stops 1305 are of one piece with bite funnel 1205, as shown. Preferably, bite stops 1305 prevent the user from completely collapsing bite funnel 1205 closed, thereby stopping or limiting fluid flow, in use, as shown. Upon reading the teachings of this specification, those of ordinary skill in the art will now understand that, under appropriate circumstances, such as user preference, advances in technology, intended use, etc., other bite stops, such as separate bite stops, bite stops of other shapes, other quantities of bite stops, etc., may suffice.

FIG. 13B shows a sectional view of the preferred embodiment according to FIG. 13A, in an open position. Preferably, when bite funnel 1205 is properly compressed, bite stops 1305 come together and prevent further compression, as shown. Upon reading the teachings of this specification, those of ordinary skill in the art will now understand that, under appropriate circumstances, such as user preference, advances in technology, intended use, etc., other arrangements, such as incremental bite stops, resilient bite stops, bite stops that lock the valve open, etc., may suffice.

FIG. 13C shows a front view of the preferred embodiment according to FIG. 13A, in the closed position. Preferably, bite stops 1305 (at least embodying herein wherein such duckbill opener means comprises squeeze-stop means for stopping such duckbill opener means from being squeezed closed; and at least embodying herein wherein such at least one duckbill opener comprises at least one squeeze-stop to stop such at least one duckbill opener from being squeezed closed) are small enough that they do not impede fluid flow through bite funnel 1205, as shown. Upon reading the teachings of this specification, those of ordinary skill in the art will now understand that, under appropriate circumstances, such as user preference, advances in technology, intended use, etc., other bite stops, such as bite stops that regulate fluid flow, etc., may suffice.

FIG. 13D shows a front view of the preferred embodiment according to FIG. 13A, in an open position.

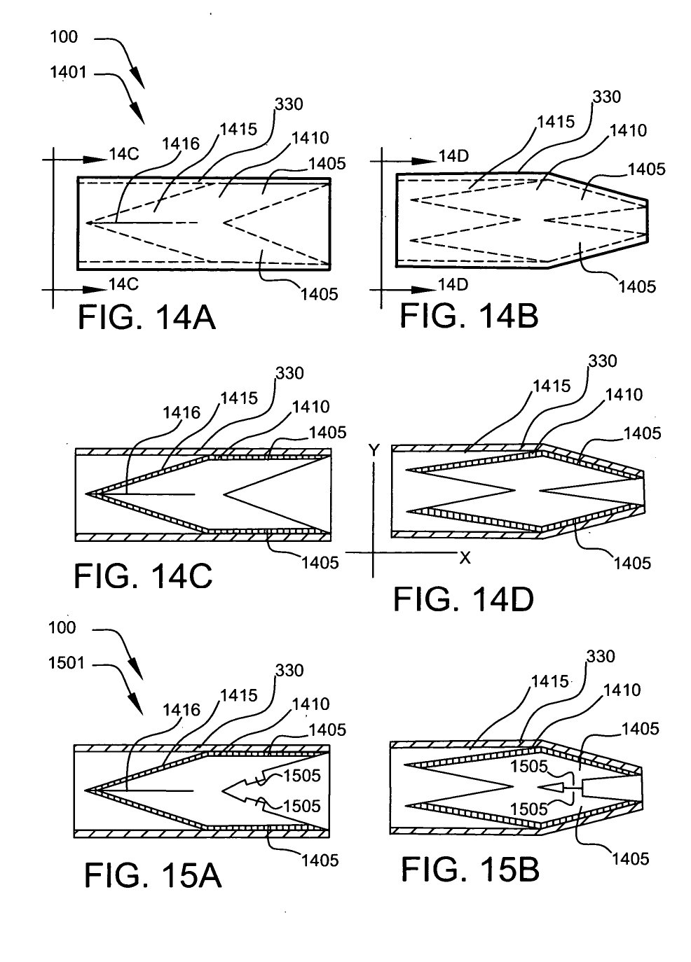

FIG. 14A shows a side view of leak-resistant drinking system 100 according to a preferred embodiment of the present invention, in the closed position. Preferably, leak-resistant drinking system 100 comprises valve 1401, as shown. Preferably, valve 1401 comprises bite levers 1405, seal portion 1410, and duckbill valve 1415, as shown. Preferably, valve 1401 fits sealably and entirely within conduit 330, as shown. Preferably, valve 1401 is made of one piece of resilient material having shape memory, such as, for example, polyethylene, as shown. Preferably, duckbill valve 1415 functions similarly to duckbill valve 1215. Preferably, seal portion 1410 functions similarly to seal portion 1210. Preferably, bite levers 1405 function similarly to bite funnel 1205. Upon reading the teachings of this specification, those of ordinary skill in the art will now understand that, under appropriate circumstances, such as user preference, advances in technology, intended use, etc., other arrangements, such as resilient layers to assist closing the duckbill valve, etc., may suffice.

FIG. 14B shows a side view of the preferred embodiment according to FIG. 14A, in an open position. Preferably, squeezing conduit 330 in the “Y” axis adjacent bite levers 1405 compresses conduit 330 and bite levers 1405, as shown, opening duckbill valve 1415 and permitting fluid flow through conduit 330 and valve 1401. Upon reading the teachings of this specification, those of ordinary skill in the art will now understand that, under appropriate circumstances, such as user preference, advances in technology, intended use, etc., other means of opening the duckbill valve, such as pressing with lips, pressing with fingers, biting, etc., may suffice.

FIG. 14C shows a sectional view of planar section 14C-14C of FIG. 14A. Preferably, seal section 1410 pressure sealably engages conduit 330 (at least embodying herein conduit means for conducting fluid; and at least embodying herein at least one conduit to conduct at least one fluid) with pressure and friction, as shown. Upon reading the teachings of this specification, those of ordinary skill in the art will now understand that, under appropriate circumstances, such as user preference, advances in technology, intended use, etc., other seals, such as adhesive, welds, etc., may suffice.

FIG. 14D shows a sectional view of planar section 14D-14D of FIG. 14B. Preferably, opening duckbill valve 1415 deforms conduit 330 slightly around duckbill valve 1415, as shown. Upon reading the teachings of this specification, those of ordinary skill in the art will now understand that, under appropriate circumstances, such as user preference, advances in technology, intended use, etc., other arrangements, such as the conduit deforming significantly, the conduit comprising a very elastic material such as rubber, etc., may suffice.

FIG. 15A shows a sectional view of leak-resistant drinking system 100 according to a preferred embodiment of the present invention, in the closed position. Preferably, valve 1501 is a variation of valve 1401, further comprising bite stops 1505, as shown. Preferably, bite stops 1505 are of one piece with bite levers 1405, as shown. Upon reading the teachings of this specification, those of ordinary skill in the art will now understand that, under appropriate circumstances, such as user preference, advances in technology, intended use, etc., other bite stops, such as separate bite stops, other quantities of bite stops, other shapes of bite stops, other locations of bite stops, etc., may suffice.

FIG. 15B shows a sectional view of the preferred embodiment according to FIG. 15A, in an open position. Preferably, when bite levers 1405 are properly compressed, bite stops 1505 come together and prevent further compression, as shown. Preferably, bite stops 1505 to not significantly impede fluid flow through valve 1501. Upon reading the teachings of this specification, those of ordinary skill in the art will now understand that, under appropriate circumstances, such as user preference, advances in technology, intended use, etc., other bite stops, such as bite stops that regulate fluid flow, etc., may suffice.

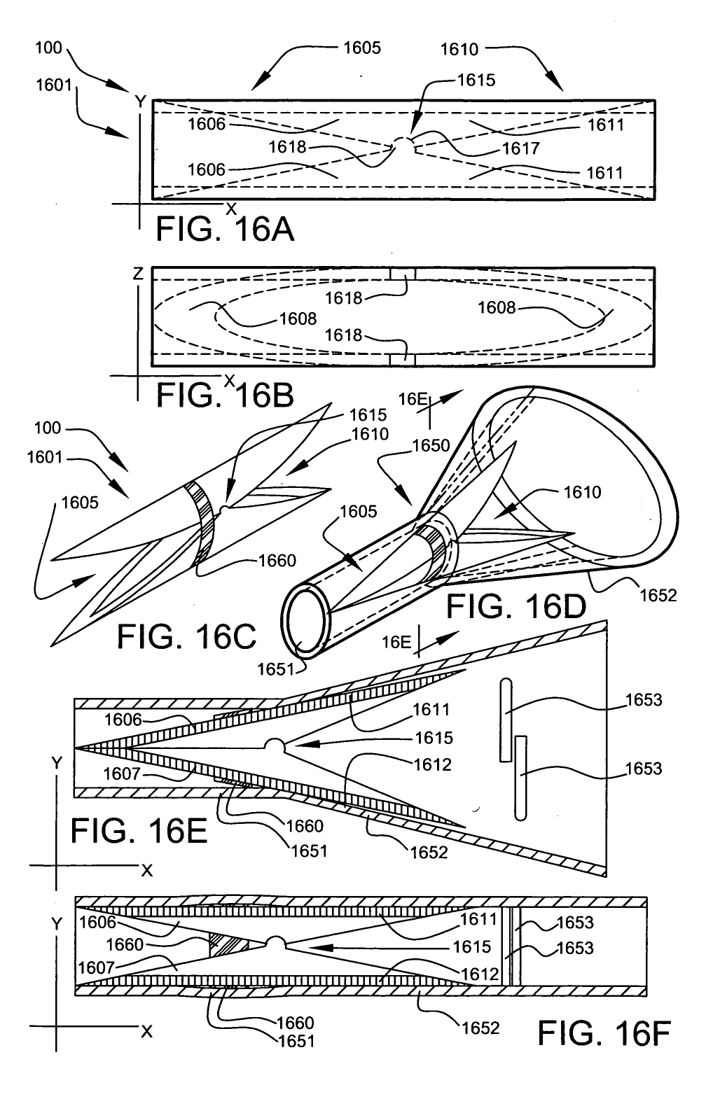

FIG. 16A shows a side view of leak-resistant drinking system 100 according to a preferred embodiment of the present invention. Preferably, leak-resistant drinking system 100 comprises valve 1601. Preferably, valve 1601 comprises duckbill valve 1605, squeeze portion 1610, and hinge 1615, as shown. Preferably, valve 1601 comprises strong, rigid material, such as, for example, polyethylene, as shown. Upon reading the teachings of this specification, those of ordinary skill in the art will now understand that, under appropriate circumstances, such as user preference, advances in technology, intended use, etc., other materials, such as polyvinyl chloride, polypropylene, other plastics, silicone rubber, rubber, metal, etc., may suffice.

Preferably, duckbill valve 1605 comprises top portion 1606 and bottom portion 1607, as shown. Preferably, top portion 1606 and bottom portion 1607 (at least embodying herein wherein such duckbill valve means comprises at least two annular cylindrical wedges; and at least embodying herein wherein such at least one duckbill valve comprises at least two annular cylindrical wedges) are matching planar sections of a hollow cylinder, as shown, and sealingly close against each other, as shown. This arrangement permits maximum fluid flow through valve 1601 in use by maximizing the open cross-section, as shown.

Preferably, squeeze portion 1610 comprises top squeeze portion 1611 and bottom squeeze portion 1612, as shown. Preferably, top squeeze portion 1611 and bottom squeeze portion 1612 are matching elliptical sections of a cylinder, as shown. This arrangement permits maximum fluid flow through valve 1601 in use by maximizing the open cross-section, as shown. Duckbill valve 1605 and squeeze portion 1610 may have the same or different elliptical section angles as each other.

Preferably, hinges 1615 comprise notches 1617 and tabs 1618, as shown. Preferably, tab 1618 acts as fulcrum on which notch 1617 “see-saws” when valve 1601 is opened and closed, as shown. Upon reading the teachings of this specification, those of ordinary skill in the art will now understand that, under appropriate circumstances, such as user preference, advances in technology, intended use, ease of manufacture, etc., other types of hinges, such as pivot hinges, pin hinges, resilient material hinges, etc., may suffice.

FIG. 16B shows a top plan view of the preferred embodiment according to FIG. 16A. Preferably, top portion 1606 and bottom portion 1607 of duckbill valve 1605 have tapered edges 1608 that assist in sealing duckbill valve 1605 in the closed position, as shown. These tapered edges 1608 are preferably a byproduct of top portion 1606 and bottom portion 1607 of duckbill valve 1605 being elliptical sections of a cylinder, as shown.

FIG. 16C shows a perspective view of the preferred embodiment according to FIG. 16A, in an open position. Preferably, duckbill valve 1605 is held in the closed position with resilient band 1660, as shown. Preferably, resilient band 1660 comprises an elastic material, such as, for example, rubber, as shown. Preferably, resilient band 1660 (at least embodying herein resilient closure means for resiliently closing such duckbill valve means; and at least embodying herein at least one resilient closure to resiliently close such at least one duckbill valve) stretches open when duckbill valve 1605 is opened by squeezing squeeze portion 1612, as shown, and pulls duckbill valve 1605 closed when squeeze portion 1612 is released, as shown. Preferably, resilient band 1660 is thin and narrow enough to permit duckbill valve 1605 (at least embodying herein wherein such at least one duckbill valve comprises at least two annular cylindrical wedges) to open almost completely, as shown, without significantly impeding fluid flow. Upon reading the teachings of this specification, those of ordinary skill in the art will now understand that, under appropriate circumstances, such as user preference, advances in technology, intended use, ease of manufacture, etc., other ways of biasing duckbill valve 1605 closed in the resting state, such as springs, resilient layers, a resilient conduit, etc., may suffice.

FIG. 16D shows a perspective view of the preferred embodiment according to FIG. 16A, inserted into flared conduit 1650. Preferably, leak-resistant drinking system 100 comprises conduit 1650. Preferably, conduit 1650 comprises straight portion 1651 and flared portion 1652 (at least embodying herein wherein such conduit means comprises at least one flared proximal end; and at least embodying herein wherein such at least one conduit comprises at least one flared proximal end), as shown. Preferably, duckbill valve 1605 and hinges 1615 fit sealably within straight portion 1651, as shown, while squeeze portion 1610 fits loosely within flared portion 1652, as shown, when valve 1601 is closed. Preferably, resilient band 1660 assists sealing duckbill valve 1605 within conduit 1650, as shown. Upon reading the teachings of this specification, those of ordinary skill in the art will now understand that, under appropriate circumstances, such as user preference, advances in technology, intended use, etc., other seals, such as adhesive, welds, notches, etc., may suffice.

FIG. 16E shows a sectional view of section 16E-16E of FIG. 16D, in the closed position. Preferably, flared portion 1652 does not compress squeeze portion 1610 in the resting (closed) state, as shown.

Preferably, flared portion 1652 comprises bite stops 1653, as shown. Preferably, bite stops 1653 overlap in the resting state, as shown, in order to help prevent a user from being pinched by bite stops 1653 when they are closing together. Preferably, bite stops 1653 are small enough that they do not impede the flow of fluid in use (such as shown in FIG. 13D). Upon reading the teachings of this specification, those of ordinary skill in the art will now understand that, under appropriate circumstances, such as user preference, advances in technology, intended use, etc., other bite stops, such as bite stops that regulate fluid flow, separate bite stops, bite stops of other shapes, other quantities of bite stops, etc., may suffice.

FIG. 16F shows a sectional view of section 16E-16E of FIG. 16D, in an open position. Preferably, valve 1601 opens when flared portion 1652 is squeezed against squeeze portion 1610, compressing squeeze portion 1610, as shown. Preferably, valve 1601 conforms closely to the inside of straight portion 1651, in the open position, as shown, in order to maximize fluid flow. Preferably, bite stops 1653 permit flared portion 1652 to be compressed until duckbill valve 1605 is completely open within straight portion 1651, as shown. Upon reading the teachings of this specification, those of ordinary skill in the art will now understand that, under appropriate circumstances, such as user preference, advances in technology, intended use, ease of manufacture, etc., other arrangements, such as duckbill valve being curved to open in a curved conduit, etc., may suffice.

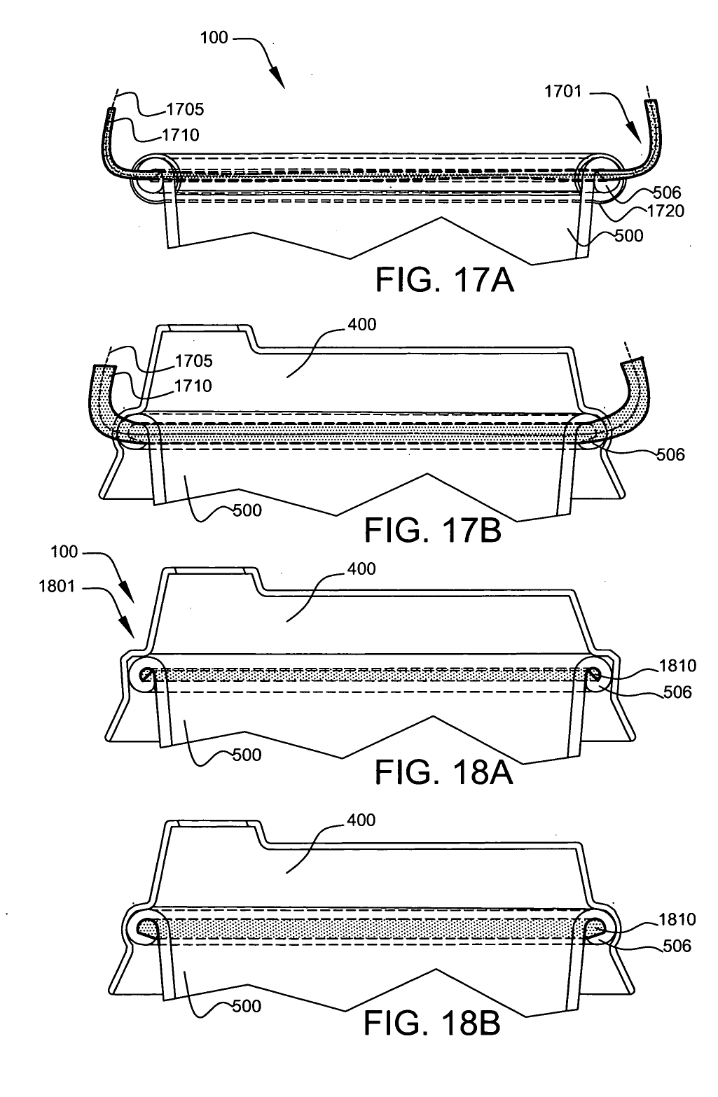

FIG. 17A shows a front view, partly in section, of leak-resistant drinking system 100 according to a preferred embodiment of the present invention, in a non-activated state. Preferably, leak-resistant drinking system 100 comprises rim expander 1701, as shown. Preferably, rim expander 1701 (at least embodying herein moisture-activatable expander means for expanding such rolled cup rim means upon contact with moisture; and at least embodying herein at least one moisture-activatable expander to expand such at least one rolled cup rim upon contact with moisture) comprises wick 1705 (at least embodying herein wherein such moisture-activatable expander means comprises support means for supporting such moisture-activatable expander means; and at least embodying herein wherein such at least one moisture-activatable expander comprises at least one support to support such at least one moisture-activatable expander), such as, for example, a cotton thread, as shown, impregnated with hygroscopic expanding material 1710, such as, for example, psillium fiber, as shown. Preferably, rim expander 1701, in a dry, non-activated state, is held within rolled rim 506 of cup 500 (at least embodying herein resilient cup means for resiliently cupping liquid; and at least embodying herein at least one resilient cup to resiliently cup at least one liquid), as shown. Preferably, rim expander 1701 is placed within the entire circumference of rolled rim 506, as shown in section. Upon reading the teachings of this specification, those of ordinary skill in the art will now understand that, under appropriate circumstances, such as user preference, advances in technology, intended use, etc., other expanding hygroscopic materials, such as sodium polymethacrylate, other polymer salts, other biological hygroscopic materials, etc., may suffice.

Preferably, rim protector 1720 prevents water vapor from coming into contact with rim expander 1701 prior to use. Preferably, rim protector 1720 comprises a slit hollow ring of resilient material that sealably fits over rolled rim 506, as shown in section. Preferably, rim protector 1720 (at least embodying herein water excluder means for excluding water from such moisture-activatable expander means prior to use; and at least embodying herein at least one water excluder to exclude water from such at least one moisture-activatable expander prior to use) is removed prior to use of cup 500, as shown, and a cup lid, such as, for example, dome-sip cup lid 400, is placed on cup 500, as shown. Upon reading the teachings of this specification, those of ordinary skill in the art will now understand that, under appropriate circumstances, such as user preference, advances in technology, intended use, etc., other means of protecting the rim expander from premature contact with water vapor, such as rim protectors of other materials, shipping rim expanders with desiccants, etc., may suffice.

FIG. 17B shows a front view, partly in section, of the preferred embodiment according to FIG. 17A, in an activated state. Preferably, when cup 500 is filled with liquid (preferably hot coffee), water vapor penetrates rolled rim 506 and is absorbed by rim expander 1701, as shown. Preferably, rim expander 1701 then expands, expanding rolled rim 506 (at least embodying herein wherein such resilient cup means comprises rolled cup rim means for providing at least one rolled cup rim of such resilient cup means; and at least embodying herein wherein such at least one resilient cup comprises at least one rolled cup rim to provide at least one rolled cup rim of such at least one resilient cup), as shown, and pressing rolled rim 506 more tightly against domed-sip cup lid 400 for a tighter, more leak-resistant fit, as shown. Upon reading the teachings of this specification, those of ordinary skill in the art will now understand that, under appropriate circumstances, such as user preference, advances in technology, intended use, etc., other arrangements, such as other types of cup lids, the rim expander being on the outside of the cup, the rim expander being on the inside of the cup lid, etc., may suffice.

FIG. 18A shows a front view, partly in section, of leak-resistant drinking system 100 according to a preferred embodiment of the present invention, in a non-activated state. Preferably, leak-resistant drinking system 100 comprises rim expander 1801, as shown. Preferably, rim expander 1801 comprises hygroscopic expanding material 1810, such as, for example, sodium polymethacrylate, as shown. Preferably, rim expander 1801 (at least embodying herein wherein such moisture-activated expander means lies within such rolled cup rim means; and at least embodying herein wherein such at least one moisture-activated expander lies within such at least one rolled cup rim), in a dry, non-activated state, is held within rolled rim 506 of cup 500, as shown. Preferably, rim expander 1801 is placed within the entire circumference of rolled rim 506, as shown in section. Preferably, rim expander 1801 is adhered to cup 500 prior to the rim-rolling cup manufacturing operation. Upon reading the teachings of this specification, those of ordinary skill in the art will now understand that, under appropriate circumstances, such as user preference, advances in technology, intended use, etc., other expanding hygroscopic materials, such as psillium fiber, other polymer salts, other biological hygroscopic materials, etc., may suffice.

FIG. 18B shows a front view, partly in section, of the preferred embodiment according to FIG. 18A, in an activated state. Preferably, when cup 500 (at least embodying herein cup means for cupping liquid; and at least embodying herein at least one cup to cup at least one liquid) is filled with liquid (preferably hot coffee or tea), water vapor penetrates rolled rim 506 and is absorbed by hygroscopic expanding material 1810, as shown. Preferably, rim expander 1801 then expands, expanding rolled rim 506, as shown, and pressing rolled rim 506 more tightly against domed-sip cup lid 400 (at least embodying herein cup lid means for lidding such cup means; and at least embodying herein at least one cup lid to lid such at least one cup) for a tighter, more leak-resistant fit, as shown. Upon reading the teachings of this specification, those of ordinary skill in the art will now understand that, under appropriate circumstances, such as user preference, advances in technology, intended use, etc., other arrangements, such as other types of cup lids, the rim expander being on the outside of the cup, the rim expander being on the inside of the cup lid, etc., may suffice.

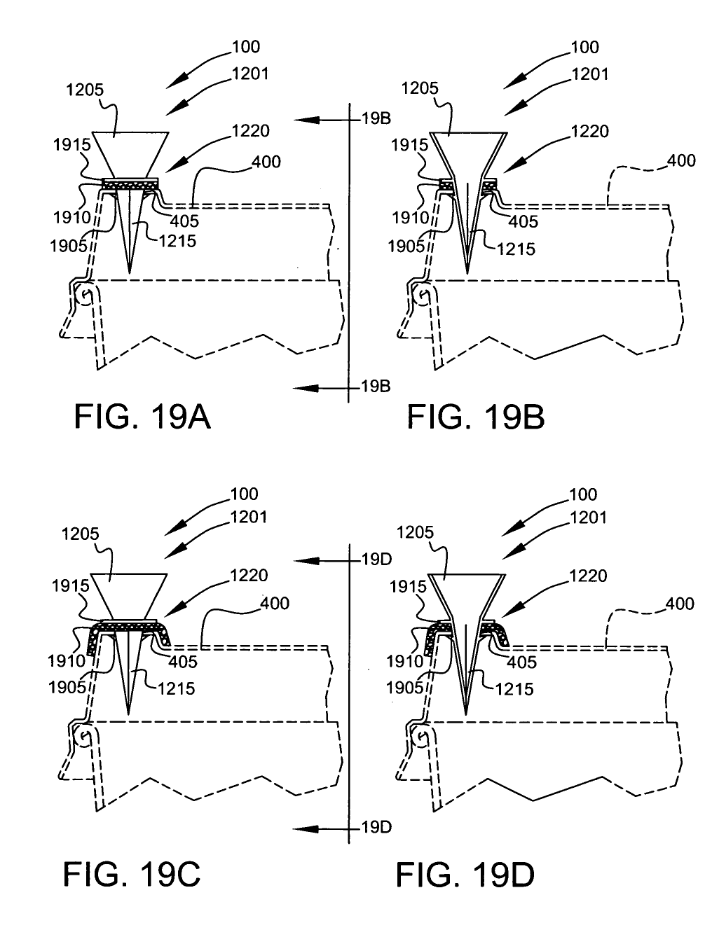

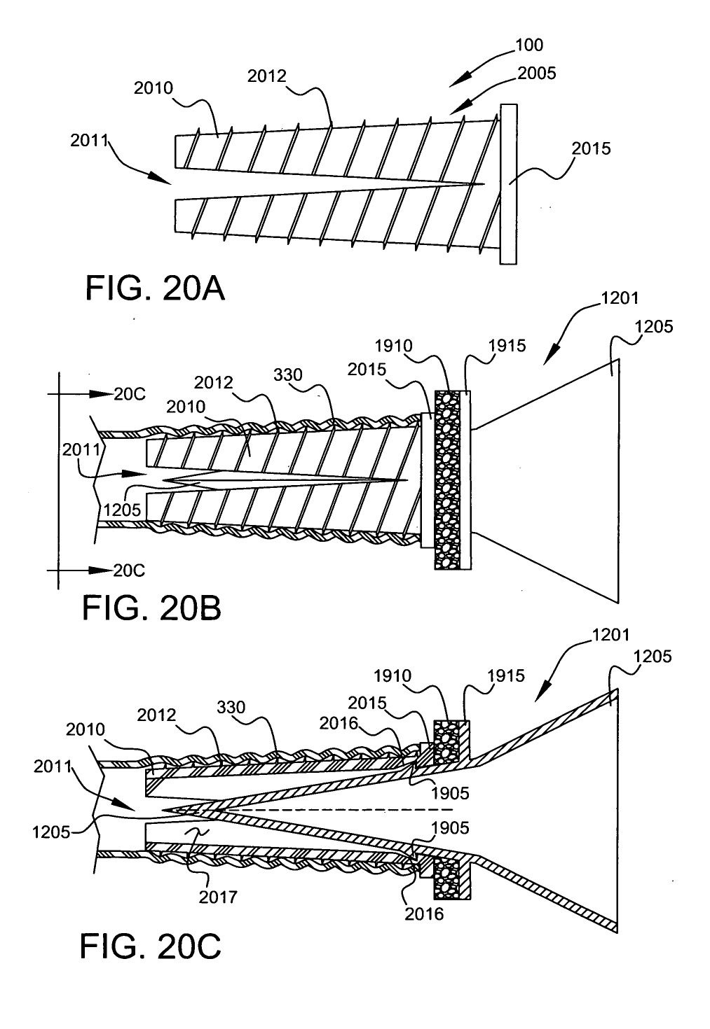

FIG. 19A shows a side view of a variation of leak-resistant drinking system 100 according FIG. 12A. Domed-sip cup lid 400 is shown in section for clarity. Preferably, valve 1201 is adapted to be used where conduit 330 comprises a cup-lid aperture (instead of or in addition to comprising a tube or straw as previously described), such as, for example, racetrack aperture 405 in domed-sip cup lid 400, as shown. Upon reading the teachings of this specification, those with ordinary skill in the art will now understand that, under appropriate circumstances, considering such issues as advances in technology, user preference, materials costs, etc., other conduits, such as other types of cup-lid apertures, other shapes of cup-lid apertures, other types of container openings, etc., may suffice.

Preferably, conduit stop 1220 comprises gasket 1910 and gasket support 1915, as shown. Preferably, gasket 1910 is pressed up against racetrack aperture 405 by gasket support 1915 in use, as shown, and helps to seal the interface between valve 1201 and racetrack aperture 405 against leaks. Preferably, gasket 1910 surrounds the entire circumference of valve 1201, as shown. Preferably, gasket 1910 (at least embodying herein wherein such at least one gasket is substantially flat) extends from valve 1201 to the edges of gasket support 1915, as shown. Preferably, gasket 1910 comprises a layer of resilient material, preferably resilient closed-cell foam, most preferably closed-cell foam rubber. Preferably, gasket 1910 also assists holding duckbill valve 1215 closed, while being resilient enough to permit duckbill valve 1215 to open when bite funnel 1205 is squeezed. Upon reading the teachings of this specification, those with ordinary skill in the art will now understand that, under appropriate circumstances, considering such issues as advances in technology, user preference, etc., other gasket materials, such as other polymer foams, silicone rubber, other solid resilient materials, adhesives to secure the gasket to the cup lid, etc., may suffice.

Preferably, valve 1201 comprises ratchets 1905, as shown, that are preferably placed on the duckbill valve 1215 side of conduit stop 1220, as shown, preferably adjacent conduit stop 1220, as shown. Preferably, ratchets 1905 are angled toward conduit stop 1220, as shown. Preferably, ratchets 1905 help prevent valve 1201 from being removed from racetrack aperture 405 during use. Preferably, ratchets 1905 and conduit stop 1220 function together to hold valve 1201 in place in racetrack aperture 405, as shown. Preferably, ratchets 1905 are held compressed against the inside of domed-sip cup lid 400 by pressure exerted against the outside of domed-sip cup lid 400 by conduit stop 1220, preferably by compressed gasket 1910, as shown. Upon reading the teachings of this specification, those with ordinary skill in the art will now understand that, under appropriate circumstances, considering such issues as advances in technology, user preference, cup lid shape, etc., other arrangements, such as other quantities of ratchets, other shapes of ratchets, other placements of ratchets, etc., may suffice.

FIG. 19B shows a sectional view of section 19B-19B of FIG. 19A.

FIG. 19C shows a side view of a variation of leak-resistant drinking system 100 according to FIG. 19A. In a preferred variation of the leak-resistant drinking system according to FIG. 19A, at least one portion of gasket 1910 (at least embodying herein wherein such at least one gasket is shaped to conform to the perimeter of the at least one conduit) extends past the edges of gasket support 1915 (at least embodying herein wherein such at least one duckbill seal comprises at least one support adapted to support such at least one gasket), as shown, preferably conforming to the shape of at least one portion of domed-sip cup lid 400 to provide additional leak protection, as shown. Upon reading the teachings of this specification, those with ordinary skill in the art will now understand that, under appropriate circumstances, considering such issues as advances in technology, user preference, etc., other arrangements, such as the gasket support conforming to the shape of the gasket, etc., may suffice.

FIG. 19D shows a sectional view of section 19D-19D of FIG. 19C.

FIG. 20A shows a side view of leak-resistant drinking system 100 according to a preferred embodiment of the present invention. Preferably, leak-resistant drinking system 100 comprises connector 2005, as shown. Preferably, connector 2005 permits variations of valve 1201 having ratchets 1905 (and preferably having gasket 1910) to be installed in a substantially tubular conduit 330, as shown in FIG. 20B. Preferably, connector 2005 is adapted to connect to conduit 330 and valve 1201, and to permit fluid flow between conduit 330 and valve 1201, preferably through connector 2005. Preferably, connector 2005 provides a leak-resistant connection between conduit 330 and valve 1201. Preferably, connector 2005 comprises plastic. Upon reading the teachings of this specification, those with ordinary skill in the art will now understand that, under appropriate circumstances, considering such issues as advances in technology, user preference, etc., other arrangements, such as other materials, connections to other types of conduits, may suffice.

FIG. 20B shows a side view of leak-resistant drinking system 100 according FIG. 20A, installed in conduit 330, and holding the variation of leak-resistant drinking system 100 according FIG. 12A. Conduit 330 is shown in section for clarity. Preferably, connector 2005 comprises conduit connector 2010, as shown, that is preferably adapted to be inserted into conduit 330, as shown. Preferably, conduit connector 2010 is slightly tapered, as shown, to ease insertion into conduit 330. Preferably, conduit connector 2010 comprises notch 2011 (at least embodying herein wherein such at least one conduit connector comprises at least one notch), as shown, to permit the end of conduit connector 2010 to be compressed to further ease insertion into conduit 330. Preferably, conduit connector 2010 screws into conduit 330 with threads 2012 (at least embodying herein wherein such at least one conduit connector comprises at least one screw), as shown, stretching conduit 330 to conform to conduit connector 2010 (at least embodying herein wherein such at least one connector comprises at least one conduit connector adapted to connect to such at least one conduit), as shown, and providing a leak-resistant seal between connector 2005 and conduit 330. Upon reading the teachings of this specification, those with ordinary skill in the art will now understand that, under appropriate circumstances, considering such issues as advances in technology, user preference, etc., other conduit connector arrangements, such as friction fitting without threads, use of adhesive, connecting to the exterior of the conduit, etc., may suffice.

Preferably, connector 2005 comprises valve connector 2015, as shown, that is preferably adapted to receive valve 1201, as shown. Preferably, valve 1201 is inserted into valve connector 2015 (at least embodying herein wherein such at least one connector comprises at least one duckbill valve connector adapted to connect to such at least one duckbill valve), as shown, preferably forming a leak-resistant seal. Upon reading the teachings of this specification, those with ordinary skill in the art will now understand that, under appropriate circumstances, considering such issues as advances in technology, user preference, etc., other valve connector arrangements, such as other shapes, sealants, etc., may suffice.

FIG. 20C shows a sectional view of section 20C-20C of FIG. 20B. Preferably, connector 2005 (at least embodying herein at least one connector adapted to connect such at least one duckbill valve to such at least one conduit) comprises fluid passage 2017 (at least embodying herein wherein such at least one connector comprises at least one fluid passage adapted to permit fluid passage between such at least one conduit and such at least one duckbill valve) that permits fluid passage through connector 2005 between conduit 330 and valve 1201. Preferably, valve connector 2015 comprises one or more detents 2016 adapted to receive ratchets 1905 on valve 1201, as shown. Preferably, ratchets 1905 (at least embodying herein wherein such at least one duckbill seal comprises at least one ratchet adapted to ratchet such at least one duckbill valve into such at least one conduit) and conduit stop 1220 function together to hold valve 1201 in place in valve connector 2015, as shown. Preferably, ratchets 1905 are held compressed against the inside of detents 2016 (at least embodying herein wherein such at least one duckbill valve connector comprises at least one detent) by pressure exerted against the outside of valve connector 2015 by conduit stop 1220, preferably by compressed gasket 1910 (at least embodying herein wherein such at least one duckbill seal comprises at least one gasket adapted to seal the exterior of such at least one conduit), as shown. Upon reading the teachings of this specification, those with ordinary skill in the art will now understand that, under appropriate circumstances, considering such issues as advances in technology, user preference, etc., other arrangements, such as other detent placements, other numbers of detents, multiple layers of detents permitting multiple depths of ratchet placement, etc., may suffice.

Although applicant has described applicant's preferred embodiments of this invention, it will be understood that the broadest scope of this invention includes such modifications as diverse shapes and sizes and materials. Such scope is limited only by the below claims as read in connection with the above specification.

Further, many other advantages of applicant's invention will be apparent to those skilled in the art from the above descriptions and the below claims.

1) A double check-valve system, relating to control of the flow of fluid through at least one conduit, comprising:
a) at least one first check valve adapted to valve the forward flow of fluid;
b) at least one second check valve adapted to valve the backward flow of fluid; and
c) at least one squeeze opener adapted to squeeze open said at least one first check valve and said at least one second check valve simultaneously.

2) A leak-resistant drinking system, relating to control of the flow of fluid through at least one valve, comprising:
a) at least one first check valve adapted to valve the forward flow of fluid;
b) at least one second check valve adapted to valve the backward flow of fluid; and
c) at least one squeeze opener adapted to squeeze open said at least one first check valve and said at least one second check valve simultaneously.

3) The leak-resistant drinking system, according to claim 2, wherein:
a) said at least one first check valve comprises at least one first valve hinge adapted to assist opening of said at least one first check valve; and
b) aid at least one second check valve comprises at least one second valve hinge adapted to assist opening of said at least one second check valve.

4) The leak-resistant drinking system, according to claim 2, further comprising:
a) at least one first resilient closure adapted to resiliently close said at least one first check valve; and
b) at least one second resilient closure adapted to resiliently close said at least one second check valve.

5) The leak-resistant drinking system, according to claim 2 further comprising:
a) at least one conduit to conduct at least one fluid;
b) at least one double-check squeeze valve adapted to double-check squeeze valve control of the flow of the at least one fluid through said at least one conduit; and
c) at least one resilient closure adapted to resiliently close said at least one double-check squeeze valve;
d) wherein said at least one double-check squeeze valve is housed within said at least one conduit; and
e) wherein said at least one double-check squeeze valve is openable by at least one squeeze transmittable to said at least one conduit adjacent said at least one double-check squeeze valve; and
f) wherein said at least one double-check squeeze valve comprises said at least one first check valve, said at least one second check valve, and said at least one squeeze opener.

6) The leak-resistant drinking system, according to claim 5, wherein said at least one double-check squeeze valve comprises at least one valve hinge to assist opening of said at least one double-check squeeze valve.

7) The leak-resistant drinking system, according to claim 5, wherein:
a) said at least one conduit comprises at least one positioner to position said at least one double-check squeeze valve in a correct orientation relative to at least one user; and
b) said at least one positioner comprises said at least one conduit, wherein said at least one conduit is permanently angled.

8) The leak-resistant drinking system, according to claim 5, wherein said at least one conduit comprises at least one tapered distal end to taper at least one distal end of said at least one conduit.

9) The leak-resistant drinking system, according to claim 5, wherein said at least one conduit comprises at least one valve holder to hold said at least one double-check squeeze valve within said at least one conduit.

10) The leak-resistant drinking system, according to claim 5, further comprising at least one cushion to cushion said at least one conduit.

11) The leak-resistant drinking system, according to claim 10, wherein said at least one cushion further comprises at least one indicia.

12) The leak-resistant drinking system, according to claim 10, wherein said at least one cushion further comprises at least one resilient coating to resiliently coat said at least one cushion.

13) The leak-resistant drinking system, according to claim 10, wherein said at least one cushion further comprises at least one substantially curved sectional profile.

14) The leak-resistant drinking system, according to claim 5, further comprising:
a) at least one cup to cup fluid;
b) at least one cup lid to lid said at least one cup; and
c) at least one conduit aperture adapted to pass said at least one conduit through said at least one cup lid.

15) The leak-resistant drinking system, according to claim 14, wherein said at least one conduit comprises at least one positioner to position said at least one double-check squeeze valve relative to said at least one conduit aperture.

16) The leak-resistant drinking system, according to claim 15, wherein said at least one positioner comprises adhesive to adhere said at least one conduit to said at least one cup lid.

17) The leak-resistant drinking system, according to claim 15, wherein said at least one positioner comprises at least one surface conformation of said at least one conduit adapted to engage said at least one conduit within said at least one conduit aperture.

18) The leak-resistant drinking system, according to claim 14, wherein said at least one conduit extends through said at least one conduit aperture into said at least one cup.

19) The leak-resistant drinking system, according to claim 14, wherein said at least one conduit extends through said at least one conduit aperture into said at least one cup substantially the distance between said at least one conduit aperture and at least one portion of at least one bottom of said at least one cup.

20) The leak-resistant drinking system, according to claim 14, wherein at least one outside circumference of said at least one conduit substantially comprises at least one inside circumference of said at least one conduit aperture.

21) The leak-resistant drinking system, according to claim 14, further comprising at least one cushion to cushion said at least one conduit.

22) The leak-resistant drinking system, according to claim 21, wherein said at least one cushion extends from at least one proximal end of said at least one conduit, along the length of said at least one conduit, to adjacent said at least one cup lid.

23) The leak-resistant drinking system, according to claim 21, wherein said at least one cushion assists sealing said at least one conduit aperture.

24) A leak-resistant drinking system, relating to control of the flow of fluid through at least one conduit, comprising:
a) at least one duckbill valve to duckbill valve the flow of fluid through the at least one conduit, wherein said at least one duckbill valve is locatable within the at least one conduit;
b) at least one duckbill opener to open said at least one duckbill valve; and
c) at least one duckbill seal to sealably engage the at least one conduit
i) wherein said at least one duckbill seal is between said at least one duckbill valve and said at least one duckbill opener, and
ii) wherein said at least one duckbill seal is locatable within the at least one conduit;
d) wherein squeezing of said at least one duckbill opener is operable to open said at least one duckbill valve.

25) The leak-resistant drinking system, according to claim 24, wherein said at least one duckbill seal further comprises at least one stop to stop said at least one duckbill squeeze valve relative to the at least one conduit.

26) The leak-resistant drinking system, according to claim 24, wherein said at least one duckbill opener comprises at least one squeeze-stop to stop said at least one duckbill opener from being squeezed closed.

27) The leak-resistant drinking system, according to claim 24, further comprising at least one conduit to conduct at least one fluid.

28) The leak-resistant drinking system, according to claim 24, wherein said at least one duckbill valve comprises at least two annular cylindrical wedges.

29) The leak-resistant drinking system, according to claim 24, wherein said at least one duckbill opener is located within the at least one conduit.

30) The leak-resistant drinking system, according to claim 24, wherein said at least one duckbill opener is located outside of the at least one conduit.

31) The leak-resistant drinking system, according to claim 24, further comprising the at least one conduit, wherein said at least one conduit comprises at least one flared proximal end.

32) The leak-resistant drinking system, according to claim 24, wherein said at least one duckbill seal comprises at least one ratchet adapted to ratchet said at least one duckbill valve into such at least one conduit.

33) The leak-resistant drinking system, according to claim 24, wherein said at least one duckbill seal comprises at least one gasket adapted to seal the exterior of such at least one conduit.

34) The leak-resistant drinking system, according to claim 33, wherein said at least one gasket is shaped to conform to the perimeter of the at least one conduit.

35) The leak-resistant drinking system, according to claim 34 further comprising:
a) at least one connector adapted to connect said at least one duckbill valve to said at least one conduit;
b) wherein said at least one connector comprises at least one conduit connector adapted to connect to such at least one conduit;
c) wherein said at least one connector comprises at least one duckbill valve connector adapted to connect to such at least one duckbill valve; and
d) wherein said at least one connector comprises at least one fluid passage adapted to permit fluid passage between such at least one conduit and such at least one duckbill valve.

36) The leak-resistant drinking system, according to claim 35, wherein said at least one conduit connector comprises at least one screw.

37) The leak-resistant drinking system, according to claim 35, wherein said at least one conduit connector comprises at least one notch.

38) The leak-resistant drinking system, according to claim 35, wherein said at least one duckbill valve connector comprises at least one detent.
